(19) United States
(12) Patent Application Publication
(10) Pub. No.: US 2005/0240456 A1
(43) Pub. Date: Oct. 27, 2005

(54) Independent research analysis, aggregation and delivery system and method

(76) Inventors: Christian James Ward, Hoboken, NJ (US); Sean Robert McMahon, New York, NY (US)

Correspondence Address: PILLSBURY WINTHROP SHAW PITTMAN, LLP, P.O. BOX 10500, MCLEAN, VA, 22102, US

(21) Appl. No.: 10/832,460

(22) Filed: Apr. 27, 2004

(51) Int. Cl. G06F 17/60

(52) U.S. Cl. 705/7

(57) ABSTRACT

An independent research aggregation, analysis and delivery system and method are provided for enabling automated aggregation, analysis and delivery of, independent research relating to a plurality of securities provided by a plurality of independent research providers under the direction of a financial investment firm representative.

### BACKGROUND OF THE INVENTION

1. Field of the Invention

The present invention relates to a method and system for aggregating and delivering financial research generated by independent research providers in an automated manner.

2. Description of Related Art

In the wake of allegations and investigations of undue influence of investment banking interests on research at securities brokerage firms, the Securities Exchange Commission (SEC) entered into a Global Research Analyst Settlement with ten securities brokerage firms and announced Apr. 28, 2003 (hereafter referred to as the “Global Research Analyst Settlement” or the “Settlement”).

The Settlement requires those brokerage firms subject to the Settlement to provide their customers (e.g., institutional clients and individual investors) with additional independent research on various securities offered for sale to the firm's customers. Thus, those firms must purchase independent, third-party research for their customers for some period of time (e.g., five years) from Independent Research Providers (IRPs). As a result, each firm is required to retain an independent research monitor, also known as a Independent Consultant (IC), who, in consultation with U.S. government regulators, oversees the process of purchasing independent research to ensure that the research is high quality and useful to the firm's customers. The Settlement requires those firms to provide customers with independent, third-party research, at no cost to them, whenever the firm solicits investors to purchase securities that are covered by a firm's own research, i.e., the securities are included in the firm's coverage universe. Those firms must notify customers of the availability of independent research on their customer account statements, on the first page of research reports and on the firms' websites. Additionally, those firms must include, in each securities trade confirmation sent to the customer, the recommendation ratings, e.g., buy, sell, hold, if any, contained in the firm's own research reports and in the IRP research for the traded security.

Traditionally, the performance of independent research in the financial community has been a “cottage industry” composed of former sell-side analysts, academics, consultants, industry veterans and other experts in various fields of study. IRPs have been providing insight to investment institutions for decades, but until recently, this niche market was overshadowed by the marketing efforts of investment banking research and grew more by word of mouth than sales representation or corporate relationships.

Because IRPs do not engage in corporate finance or investment banking activities, the research they produce may be their only source of revenue. This fact more directly aligns their interests with investors as they can only continue to operate if their investment research adds value to the investor. Additionally, independent research retains the freedom to place negative or “sell” recommendations on securities, which has particularly been of interest to institutional investors seeking second opinions on investment bank or in-house recommendations.

Although at least one conventional independent research aggregation system offers an independent research analysis and delivery service that assists the institutional investment community in identifying and implementing independent research solutions, such a conventional system lacks involvement of an IC. Such a conventional system offered by an Independent Research Consultancy (IRC) aggregates, tracks, validates, and markets research that is originally generated by various IRPs. That system works with IRPs, employing distinct methodologies of investment analysis, including economic, industry, and security-specific research from fundamental, technical, and quantitative perspectives, as well as additional areas of coverage such as forensic accounting, patent portfolio valuation, corporate branding, corporate governance, and social responsibility analysis. Using that conventional system, the analytical results of utilizing these methodologies and analyses are conventionally provided to brokerage firms and other financial investment firms.

As illustrated in FIG. 1, such a conventional system 100 aggregates securities research from a plurality of IRPs 110, organizes that research into a database 120, analyzes that research to formulate certain information, such as consensus indicators 130 (i.e., a measurement of aggregate, independent investment recommendations on equity securities) and summary information 140 (including various information on securities, such as security fundamentals obtained from third parties) and associates the organized research with the formulated consensus indicators 130 and summary information 140, and facilitates the selection of such research for independent research reports 150, generated by the system 100. These actions are performed under the direction of, or in cooperation with at least one controller 160 (which may be implemented using one or more computers communicating with the IRPs 110 using one or more communication connections). For example, a report 150 may include IRP research 170 with regard to a particular security, as well as the IRC consensus indicators 130 and the summary information 140 offered by the IRC for that security. Under the direction of the controller 160, the database 120 includes the independent research reports so that they are accessible to IRC and brokerage firm personnel.

This independent research aggregation system 100 also maintains a repository of independent security recommendations of IRPs that includes live, time-stamped recommendations in a database from which outside performance measurement firms can evaluate the accuracy and timeliness of past independent research recommendations.

Using this conventional system, a software application delivers the IRPs' independent research reports, as they are produced, directly to users' desktops and includes a platform that provides tools to streamline the research process for institutional investment clients, allowing them the ability to seamlessly find, filter and contract with the independent research services that are most beneficial to their investment philosophy. However, the use of the conventional system requires constant and repeated input from human operators associated with the IRC.

### SUMMARY OF THE INVENTION

In accordance with at least one embodiment of the invention, a system and method are provided for enabling access to, analysis of and delivery of, independent research relating to a plurality of securities provided by a plurality of IRPs under the direction of a Client-specific financial investment firm representative.

### BRIEF DESCRIPTION OF THE DRAWINGS

Various embodiments of this invention will be described in detail, with reference to the following figures, wherein:

FIG. 1 illustrates an example of a conventional independent research aggregation system;

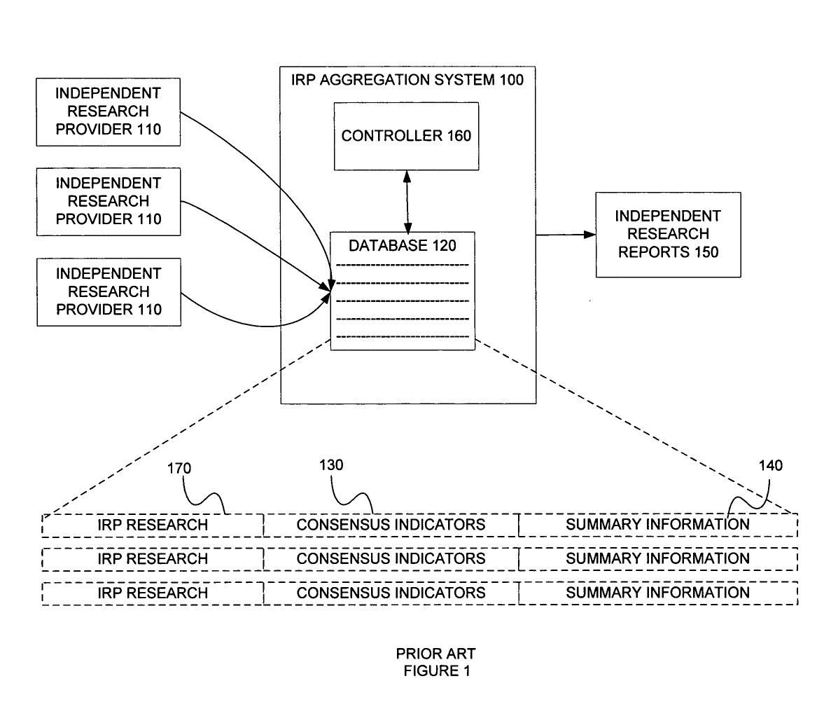

FIG. 2 illustrate an independent research aggregation, analysis and delivery system designed in accordance with at least one embodiment of the invention;

FIG. 3 is an illustrative diagram for use in explaining the selection of IRPs;

FIG. 4 illustrates one example of a front-end of an independent research aggregation, analysis and delivery system designed in accordance with at least one embodiment of the invention;

FIG. 5 illustrates one example of an “overview” screen that may be included in a front-end of an independent research aggregation, analysis and delivery system designed in accordance with at least one embodiment of the invention;

FIG. 6 illustrates one example of a “coverage universe” screen that may be included in a front-end of an independent research aggregation, analysis and delivery system designed in accordance with at least one embodiment of the invention;

FIG. 7 illustrates one example of a “security” screen that may be included in a front-end of an independent research aggregation, analysis and delivery system designed in accordance with at least one embodiment of the invention;

FIG. 8 illustrates one example of an “edit my view” window that may be included in a front-end of an independent research aggregation, analysis and delivery system designed in accordance with at least one embodiment of the invention;

FIG. 9 illustrates one example of an “override notes” window that may be included in a front-end of an independent research aggregation, analysis and delivery system designed in accordance with at least one embodiment of the invention;

FIG. 10 illustrates one example of a “security research history” screen that may be included in a front-end of an independent research aggregation, analysis and delivery system designed in accordance with at least one embodiment of the invention;

FIG. 11 illustrates one example of a “IRP list” screen that may be included in a front-end of an independent research aggregation, analysis and delivery system designed in accordance with at least one embodiment of the invention;

FIG. 12 illustrates one example of an “IRP portfolio” screen that may be included in a front-end of an independent research aggregation, analysis and delivery system designed in accordance with at least one embodiment of the invention;

FIG. 13 illustrates one example of a “change history” screen that may be included in a front-end of an independent research aggregation, analysis and delivery system designed in accordance with at least one embodiment of the invention;

FIG. 14 illustrates one example of a “search” screen that may be included in a front-end of an independent research aggregation, analysis and delivery system designed in accordance with at least one embodiment of the invention; and

FIG. 15 illustrates one example of a “preferences” screen that may be included in a front-end of an independent research aggregation, analysis and delivery system designed in accordance with at least one embodiment of the invention.

### DETAILED DESCRIPTION OF INVENTION EMBODIMENTS

As explained above, at least one conventional system is configured to deliver IRP reports and analysis and facilitate access to that research and analysis by investment firms; however, such methods and systems do not provide a mechanism for providing independent research in accordance with the Settlement announced Apr. 28, 2003. Rather, that Settlement requires that independent research be delivered in accordance with the instructions and based on analysis by, and under the guidance of, an IC.

The aftermath of the Settlement has also changed the business landscape of the financial investment industry in such a way that those brokerage firms that were not subject to the Settlement are seemingly providing less of a service to their customers than those firms that are subject to the Settlement; this is because the firms subject to the Settlement must provide independent investment research in addition to their own research, whereas those not subject to the Settlement ostensibly do not.

Therefore, even those brokerage firms that are not subject to the Settlement would find utility in a system that provides aggregation, analysis, access and automated delivery of independent research in a coordinated and efficient manner based on the instructions of a brokerage firm representative and the capabilities of an IRC.

As a result, in accordance with at least one embodiment of the invention, a system and method are provided for enabling financial investment and brokerage firms access to independent research and analysis relating to a plurality of securities and provided by a plurality of IRPs under the direction of a representative of their specific firm.

In accordance with at least a first embodiment of the invention, the system and method enable securities brokerage firms access to independent research in accordance with the Global Research Analyst Settlement under the direction of the firm's representative, which is an IC.

In accordance with at least a second embodiment of the invention, the system and method enable securities brokerage firms access to independent research from a plurality of IRPs by the firm's customers in the U.S under the direction of the firm's in-house personnel representative, e.g., a director of research or some corresponding personnel member; as an additional option, some portion of the independent research may also be made available to the client's in-house personnel via the IRC's conventional system (explained above).

Throughout the further explanation of the embodiments of the invention, brokerage firms and other financial investment entities utilizing the methods and systems of the invention are each referred to as “Clients”; that is, each firm is a Client of an organization that operates and/or maintains the systems and/or methods, i.e., the IRC. Additionally, the individuals and institutions that utilize services of each Client, are referred to as the Client's “Customers.” It should also be understood that the term IC includes each member of an IC's staff with access to the IRC's software application program and/or system designed in accordance with the embodiments of the invention, or who reviews IRP research, summary information or IRC consensus indicators (explained herein). Accordingly, it should be understood that a Client may be an investment firm or some other financial investment industry participant that desires to provide its retail and institutional Customers with independent research and information.

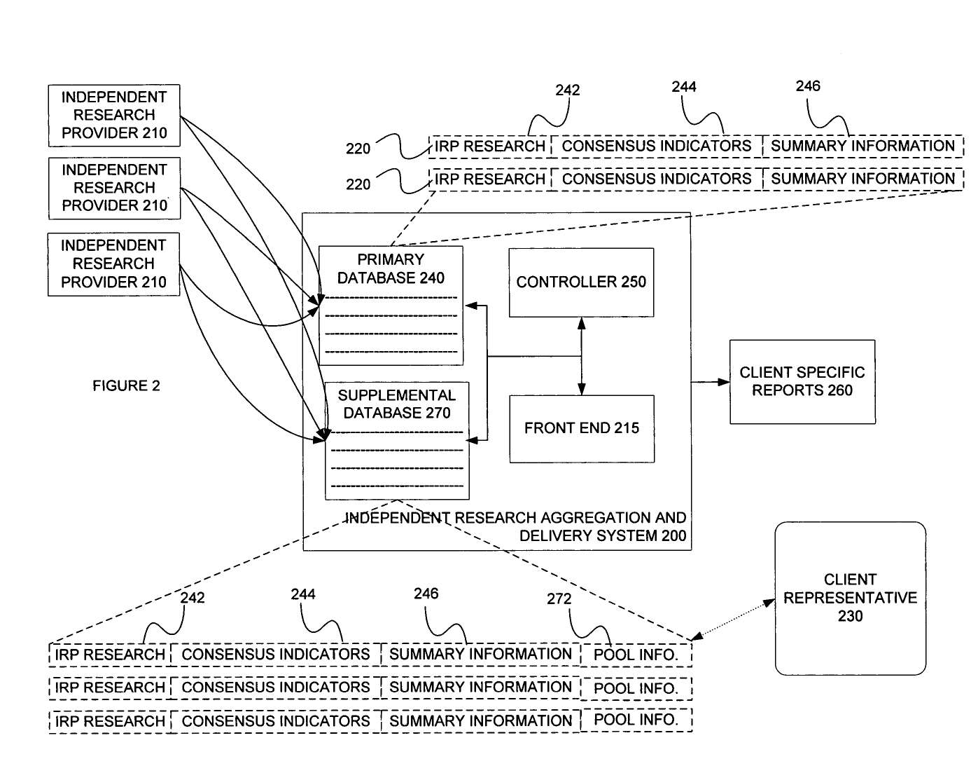

As explained with reference to FIG. 2, the IRC's independent research analysis, aggregation and delivery system 200 provides access to one or more Graphical User Interfaces (GUIs) that acts as a front end 210 to the IRC's independent research analysis, aggregation and delivery system 200 designed in accordance with the embodiments of the invention. This independent research is originally provided by IRPs selected by the IRC and contractually obligated to provide such research to the IRC.

Although it should be understood that there are various mechanisms available for transferring the IRP independent research to the independent research aggregation, analysis and delivery system, such mechanisms may include an IRP saving the research in an individual IRP-specific directory 220 included in the primary database 240 on the system 200, in an IRP-specific entry(ies) in one or more databases (primary database 240, supplemental database 270, etc.) utilized and/or included by the system 200, IRC personnel doing likewise, etc. This independent research is then organized by the independent research aggregation, analysis and delivery system 220 so as to be accessible by a Client representative 230, whether that representative be an IC (in accordance with the first embodiment of the invention) or the Client's director of research (or a like representative) (in accordance with the second embodiment of the invention).

In accordance with at least one embodiment of the invention, all IRPs post their reports to a primary IRC database 240 (similar or identical to the database used in the IRC's conventional independent research delivery system, explained above), while at the same time, the IRPs selected by a Client's representative to be included in that Client representative's IRP pool (in a methodology explained herein) also have their reports and recommendations entered into a separate, supplemental IRC database 270 within the independent research aggregation, analysis and delivery system 200. Both databases 240 and 270 may be implemented using web-based technology that permits access to report information electronically via a private and/or public network, e.g., the Internet.

The primary IRC database 240 may include independent research 242 associated with certain other information, such as consensus indicators 244 and summary information 246; therefore, in a manner similar to the conventional system, under the direction of, or in cooperation with, a controller 250 (which may be implemented using one or more computers communicating with the IRPs 210 using one or more communication connections), such research 242 is selected for inclusion in independent research reports 260, generated by the system 200. For example, a report 260 may include IRP research 242 selected by a brokerage firm with regard to a particular security (as explained herein), as well as the IRC consensus indicators 244 and the summary information 246 offered by the IRC for that security.

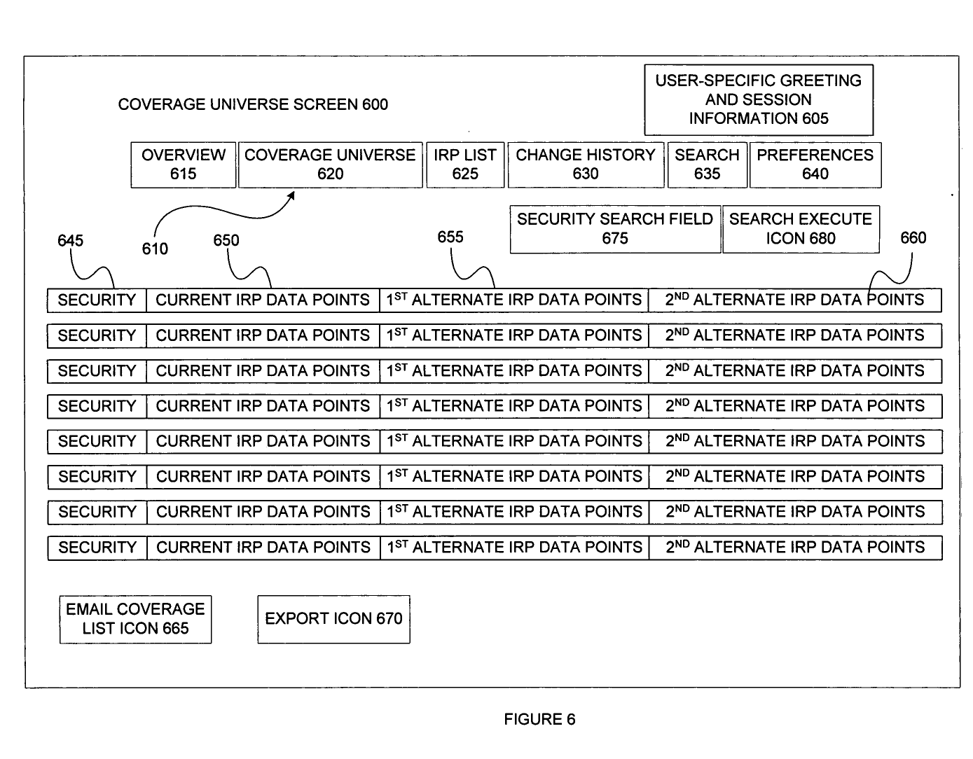

However, in addition, under the direction of the controller 250, the analysis of each of the IRPs 210 are compared to the other IRPs and the results of that analysis are stored in the supplemental IRC database 270 along with the IRP research 242. Moreover, the supplemental database 270 may include an indication of what IRPs 210 have been selected by a particular Client to be included in the Client representative's IRP pool (explained herein), as well as a information used to perform comparison of the analyses of the selected IRPs' research (explained with reference to FIGS. 6-8) on each security included in the Client's universe and associated results.

The independent research aggregation, analysis and delivery system may also provide separate data feeds to Clients should there be the need for additional data about an IRP's research and recommendations, and/or the IRC's consensus information, on trade confirmations and other documentation.

As in the conventional system provided by the IRC (explained above), the IRC may offer Clients access to consensus indicators 244, which act as a measurement of the aggregate, independent investment recommendations on equity securities 242 and provide Clients with a summary 246 of perspectives regarding a particular security across the IRP community. The consensus indicator 244 represents overall coverage and recommendations from the independent research community. Through the creation of standardizing ratings submitted from all participating IRPs, the system's consensus indicator 244 may act as a statistical benchmark issued by a broad range of persons and entities, i.e., the independent research community; as a result, the consensus indicator 244 reveals not only potential risks and opportunities in equity securities, but also presents the overall distribution of bullish and bearish securities recommendations from a broad spectrum of IRPs.

Thus, the term “consensus indicator” refers to the consensus information provided by the independent research aggregation, analysis and delivery system that is compiled and calculated using numerical designations for IRP's recommendations on a particular security obtained from the primary IRC database (see, for example, 240 in FIG. 2) to compute a consensus indicator for that security (where there is sufficient IRP data to generate such a consensus indicator). Accordingly, the consensus indicator 244 may be formulated as the average of all current recommendations by the IRCs participating IRPs for a given security. Further, the IRC may have each of its participating IRPs utilize a standardized 1 to 5 rating scale (based on their particular methodology) for each security on which they have an opinion, where a ranking of 1 may indicate the highest rated or a very positive outlook, whereas, the ranking of 5 may indicate the lowest rated or a very negative outlook.

Thus, in accordance with at least one embodiment of the invention, as each IRP submits reports to the IRC, the IRP may also be solicited to submit a rating according to the designated scale. The resulting average of all the distinct recommendations on a security may then be utilized as a gauge of overall independent research sentiment toward that particular security as well as a starting point in discovering the expertise and analytic focus of the IRPs themselves.

Because such consensus indicators are based entirely on input from IRPs, a consensus indicator may differ greatly from an aggregation of investment bank research; as a result, the consensus indicator 244 may provide an objective investment research benchmark from which investment bank and brokerage firm research may be compared. Thus, such a consensus indicator may educate investors and the investment community on not only the existence of independent research, but also (i) that the breadth of coverage in the independent community is enormous, (ii) the perspective of the analysis is different than traditional sources, and (iii) the performance of independent research recommendations may or may not consistently and significantly outperform the market.

Moreover, in accordance with at least one embodiment of the invention, every Client-specific report (i.e., report on a security included in a Client's universe) delivered to a Client and/or a Client Customer may be accompanied with a comprehensive consensus report including the consensus indicator formulated for that security and including a metric showing the average recommendation produced by aggregating all IRP recommendations on the security, the total number of IRPs with current coverage on the security included in the average recommendation, the distribution of these recommendations, e.g., positive, neutral, and negative, across the IRPs covering the security, changes in the IRC consensus data on the security over time, where the security's average recommendation ranks against other securities in its industry and sector, etc. The final result is that, in accordance with at least one embodiment of the invention, the Client can offer its Customers a proprietary research report on every security that the Client covers, a consensus indicator on the security providing a summary of perspectives across the independent research community, and one or more reports and recommendations on the security from a top performing IRP.

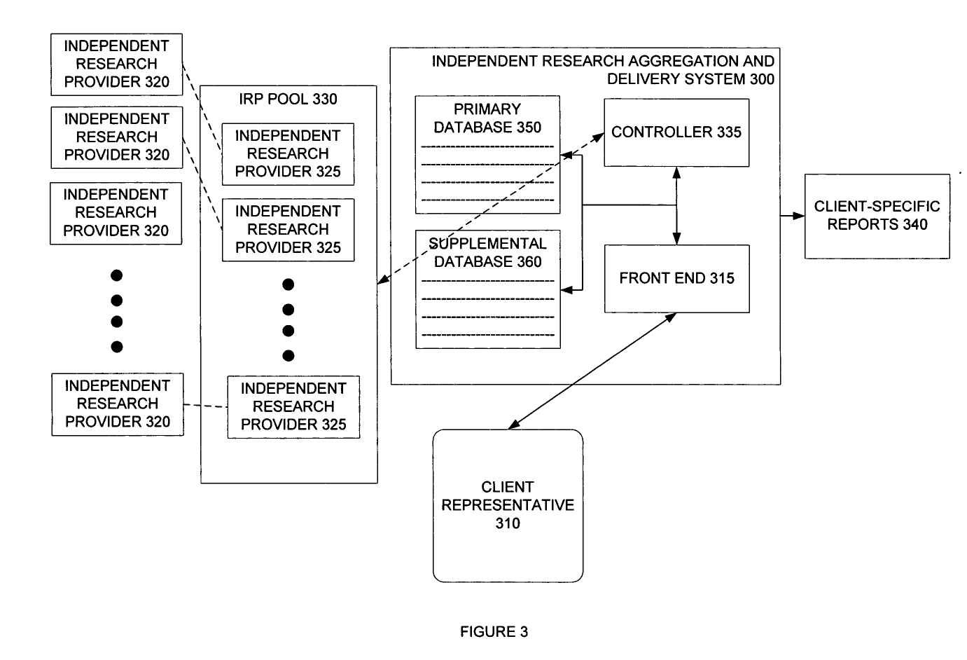

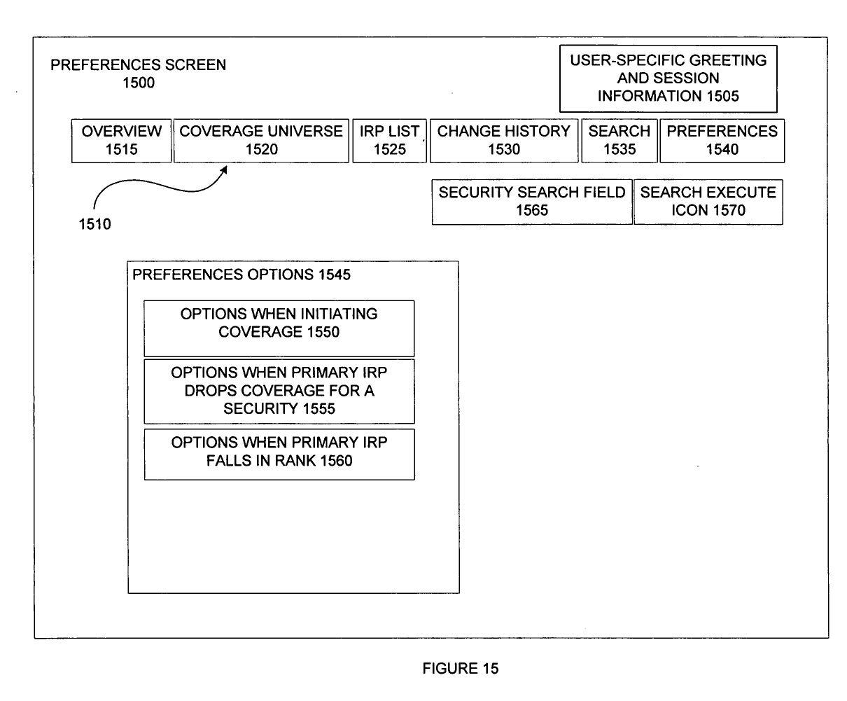

As mentioned briefly above, IRC personnel may work with a Client representative to determine specific performance measurement parameters, i.e., data points, for analyzing the research and performance of IRPs. The IRPs then selected by the Client representative to be included in the Client representative's IRP pool (explained herein with reference to FIG. 3) may then be ranked in the supplemental database 270. For example, if a particular IRP is included in one or more Clients' IRP pools, the IRP may be listed in the supplemental database 270 along with data indicating the IRP pool information 272, which may indicate to which IRP pools the IRP belongs. However, the inclusion of a particular IRP in a Client representative's IRP pool is based to some extent or another on the Client's representative's review of the IRP's past performance at predicting the behavior of the value of a particular security; moreover, the inclusion of a particular IRP in a Client representative's IRP pool may be changed at any time either on an automated basis (explained more fully with reference to a preferences window, an example of which being FIG. 15) or by the Client's representative (explained more fully with reference to an override option). Thus, in accordance with at least one embodiment of the invention, a dynamic marketplace is provided where any and all IRPs specified by a Client's representative have the opportunity to provide research on valuation of securities depending on the IRPs ability to provide accurate predictions of a security's value and/or add qualitative value.

As a result, IRPs need not receive outright contracts to provide research to particular Clients; rather, contractual obligations may be made between the IRPs and the IRC and also between the Clients and the IRC but not between the IRPs and the Client directly. To do otherwise, might cause or create the perception of complacency or conflicts of interest due to the large amounts of money that a Client may be paying an IRP directly for providing research.

Rather, all eligible IRPs have the continuous opportunity to provide their research for review by a Client representative via the primary IRC database 240. Subsequently, the Client representative may select an IRP for inclusion in its IRP pool for a particular security. Moreover, automated analysis of data points selected by the Client representative allows the controller 250 to automatically sort the IRPs included in the pool so as to indicate which one is performing best at accurately predicting behavior of the security's value (for example, by listing that IRP as a first entry on a GUI screen provided by the independent research aggregation, analysis and delivery system 200, explained herein). Depending on the preferences selected by the Client representative (see FIG. 15), such automated sorting may result in automated selection of a particular IRP as the (or one of) the primary IRPs whose research is automatically sent to the Client and/or the Client's Customers, as it is generated. Thus, that same IRP may receive compensation (in return for allowing dissemination of that IRP's analysis of that security to the Client and the Client's Customers) not because of a relationship with the particular Client, but because of their accurate analysis of one or more securities (as indicated by analysis of the Client's specified data points).

Similarly, if that particular IRP's analysis fails to accurately predict the behavior of the security's value over some period of time, automated review of the predictive accuracy of IRPs included in the Client representative's IRP pool with reference to the Client's selected data points should, ostensibly, reflect this failure. Thus, automated analysis of the Client's data points allows for the re-sorting of the IRPs based on their performance over that period and, potentially, a re-selection of a better performing IRP as a primary IRP reporting on a particular security (who in turn receives compensation from the Client in return for allowing dissemination of that IRP's analysis of the security). This, in turn, creates an environment where the Client and its Customers have a growing, changing and diverse pool of independent thought that is constantly competing to provide them with the top ranked research on each and every security covered by the Client.

As explained above, a Client representative (e.g., IC or Client in-house personnel) may select an IRP to provide independent research to be included in reports that the Client receives in an automated manner or on an ad hoc basis (via an override function, explained herein). As illustrated in FIG. 3, the Client representative 310 may transmit instructions to the independent research aggregation, analysis and delivery system 300 or IRC personnel and review information provided by that system via a front end 315 which may be comprised of one or more GUIs (explained herein). Once selected to be included in a Client representative's IRP pool by a Client representative 310, the IRC's independent research aggregation, analysis and delivery system 300, and particularly the controller 335 (based on instructions received via the front end 315), assigns an IRP 325 to be part of the associated Client representative's IRP pool 330. It should be understood that a particular IRP 325 may be selected to be part of more then one Client representative's IRP pool, for example, when that particular IRP is widely recognized as being effective at predicting the behavior of a particular security's value and/or adding qualitative value.

A Client representative's IRP pool 330 includes all IRPs 325 from whom research may be selected by that Client's representative 310 for inclusion in Client-specific reports 340 generated by and delivered to the Client and/or the Client's Customers by the independent research aggregation, analysis and delivery system 300.

As explained above, the Client representative 310 may also have access to and review the IRP independent research on securities made available by the IRC through the IRC's primary database 350. Accordingly, the IRC may issue a unique login name and password to the Client representative who is authorized to access the IRC's primary database 350. The Client representative may have access to some or all of the independent research regarding a particular security, and included in the IRC's database 350, even if it is provided by an IRP that is not in the Client representative's IRP pool 330; such access may be granted by the IRC, for example, for the purpose of determining whether to include such IRP in the Client representative's IRP pool 330. Thus, a Client's representative may have access to and review the IRP research on securities that are made available through the IRC's primary database 350 for the purpose of evaluating whether coverage for a particular security is even available. This is because, for example, IRPs may or may not provide coverage for different securities continuously.

It should also be understood that, in accordance with at least one embodiment of the invention, access to independent research provided by the system 300 and the IRC's database 350 may be initially limited to the Client representative himself. Specifically, IRC personnel may work with the Client representative 310 to execute a careful review of the existing and potential sources of independent research to be considered by the Client. This review may include a performance and coverage analysis of the IRPs' time-stamped recommendations included in the IRC's primary database 350, a comparison of IRP ticker coverage to the Client's own in-house research data, a survey of IRPs' research methodology and philosophy and sample reports, and an attestation that the IRP is independent of investment banking conflicts and evidence of such. All of these facets may be analyzed and compared not only against the requirements of the Settlement (in accordance with at least the first embodiment in which the Client representative is an IC), but may also be tailored according to the strategic or competitive goals of the Client and/or the Client's representative (in accordance with at least, both, the first and second embodiments of the invention).

Therefore, based upon the analysis performed by the Client representative 310 (in optional cooperation with IRC personnel), the Client representative 310 can indicate which IRPs he would like to have included in the Client representative's IRP pool 330. For example, in accordance with at least the first embodiment of the invention, based upon that analysis, the Client representative, i.e., the Client's IC, can indicate which IRPs it would like to be eligible to meet the Client's independent research requirement per the Settlement (i.e., Clients whose designated ICs are required to contract with at least three IRPs; those Clients also being required to provide research from at least one of those IRPs for each security in the Clients' coverage universe). Thus, a Client representative might choose thirty IRPs to be included in the Client representative's IRP pool 300 from a total of sixty IRPs researching a particular security or securities based on what the Client representative believes is an appropriate offering in compliment with the Client's own research analysis. Thus, following review of the independent research available in the primary database 350, the Client representative may select the IRP(s) to be included in the Client representative's IRP pool 330. Additionally, the Client representative may, optionally, grant access to and set up automated delivery of Client-specific reports, including independent research generated by some or all of the IRPs, to employees, agents and/or representatives of the Client and/or Client Customers.

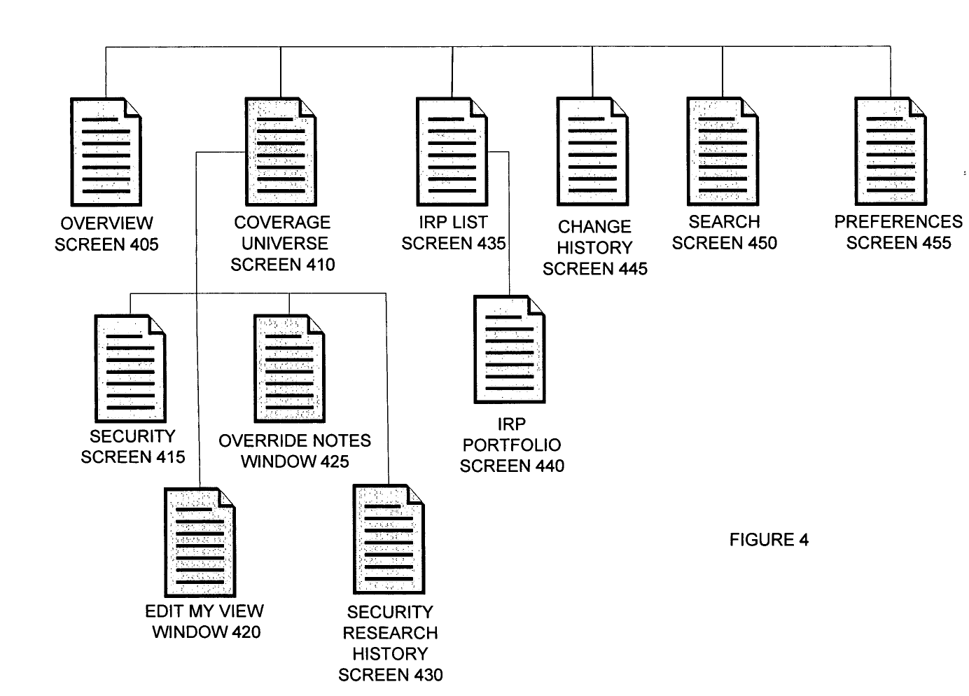

As explained above (with reference to FIGS. 2 and 3), the IRC independent research aggregation, analysis and delivery system may include a front-end IRC interface implemented as a web-site including one or more web-pages, each constituting a GUI. As illustrated in FIG. 4, the GUIs may include an “overview” screen 405, a “coverage universe” screen 410, a “security” screen 415, an “edit my view” window 420, an “override notes” window 425, a “security research history” screen 430, an “IRP list” screen 435, an “IRP portfolio” screen 440, “change history” screen 445, “search” screen 450 and “preferences” screen 455.

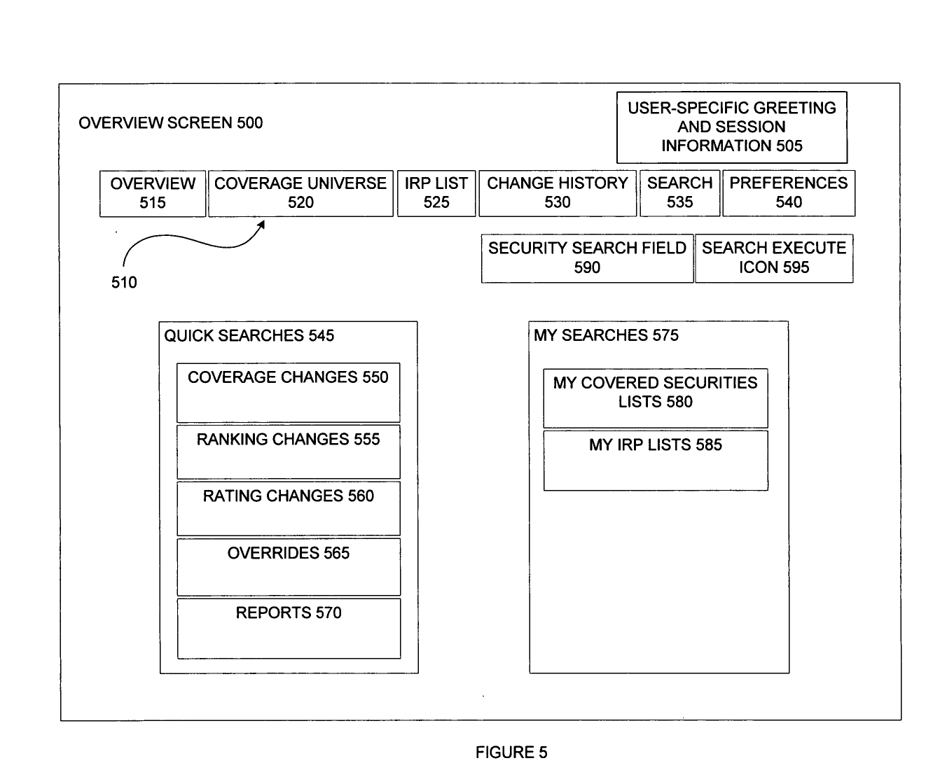

The “overview” screen 405 provides a user with access to general information provided by the independent research aggregation, analysis and delivery system as well as high level operations and links to various constituent screens (also implemented as GUIs). As illustrated in greater detail in FIG. 5, the “overview” screen 500 includes a user-specific greeting and session information 505, which may include personalized information such as a welcome message referencing the name and/or identification data of the user, e.g., the Client representative; this information may be available to the system as a result of the user being required to enter user identification data and a password to gain access to and use of the independent research aggregation, analysis and delivery system as part of a login session.

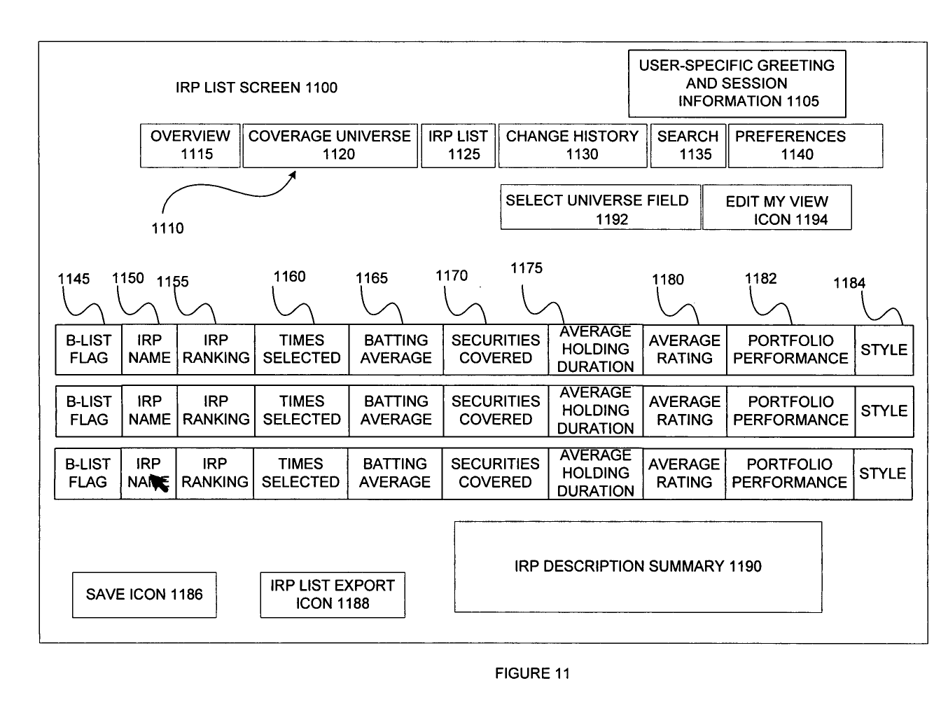

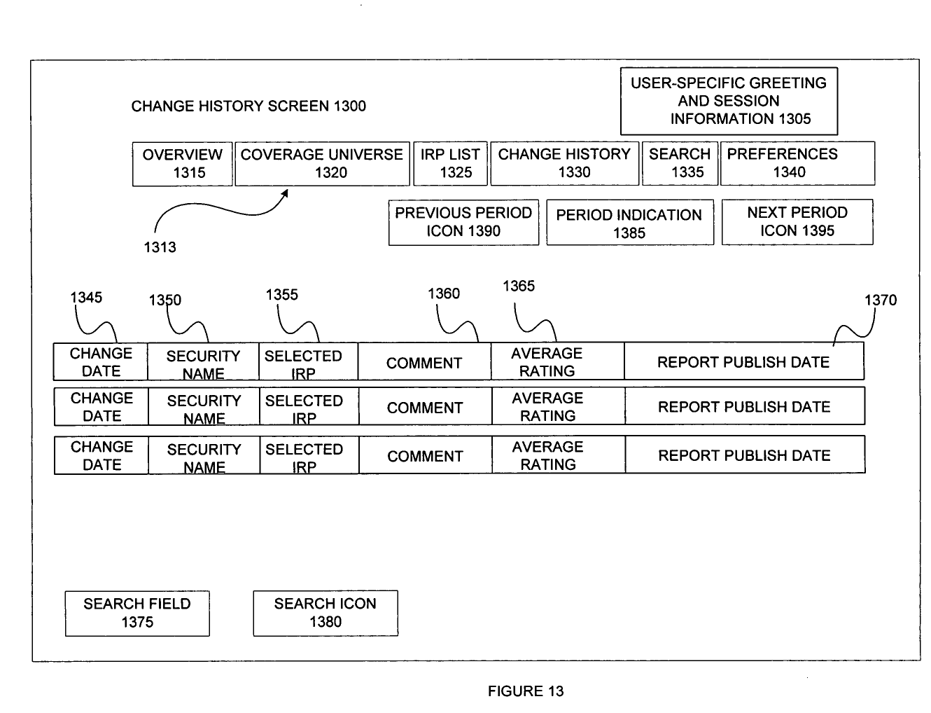

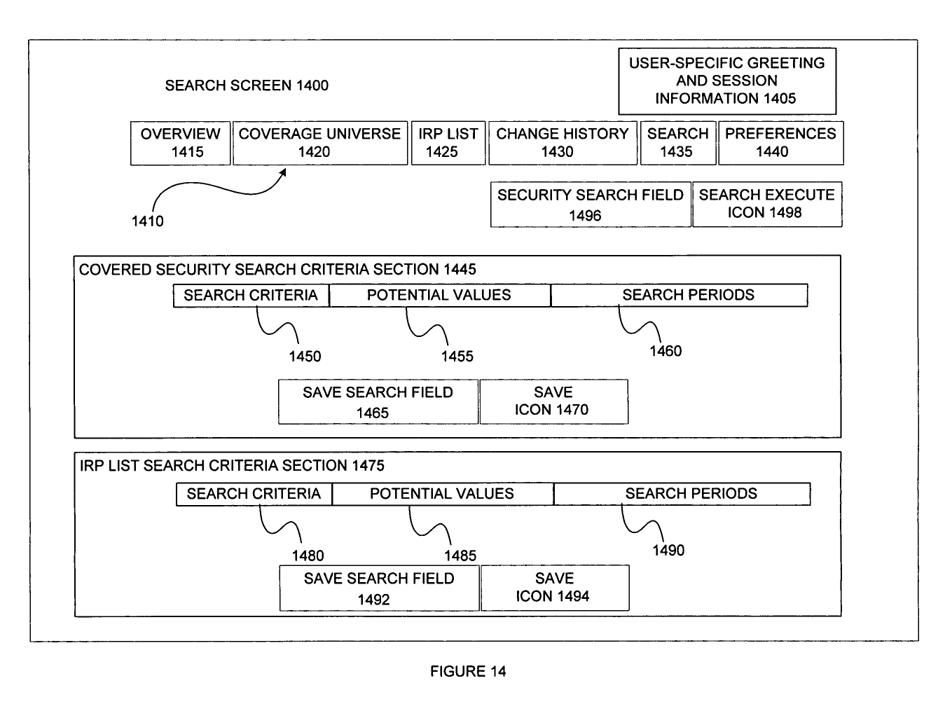

The “overview” screen 500 may also include a menu 510, which includes links to other screens included in the front-end. The menu includes an “overview” link 515, which, when excited, i.e., clicked-on using a mouse or other data input device, triggers display of the “overview” screen 500 (this menu being included on various screens included in the front-end). The menu 510 may also include a “coverage universe” link 520, which, when excited, triggers display of a “coverage universe” screen (an example of which being illustrated in FIG. 6). Also included in the menu 510, are an “IRP list” link 525 (which, when excited, triggers display of an “IRP list” screen, an example of which being illustrated in FIG. 11), a “change history” link 530 (which, when excited, triggers display of an “change history” screen, an example of which being illustrated in FIG. 13), a “search” link 535 (which, when excited, triggers display of a “search” screen, an example of which being illustrated in FIG. 14), and a “preferences” link 540 (which, when excited, triggers display of a “preferences” screen, an example of which being illustrated in FIG. 15).

The “overview” screen 500 also may include a “quick searches” section 545 devoted to various operations and options for performing quick searches, i.e., general searches that are pre-formatted to some extent and allow a user to search for information that is commonly or routinely queried. This section 545 may include a “coverage changes” subsection 550, which may include various links associated with coverage change topics and events, e.g., events such as when a Client has initiated a coverage change, when a primary IRP has dropped coverage for a particular security, when IRP(s) have initiated coverage on a security included in the Client's universe, when a Client drops coverage of a security, trading volume has changed, volume has fallen below a specified threshold, volume has surpassed a specified threshold, etc. The “overview” screen may also include other subsections including a “ranking changes” subsection 555, “rating changes” subsection 560, “overrides” subsection 565 and “reports” subsection 570.

The “ranking changes” subsection 555 may include various links associated with IRP ranking change topics, e.g., selection of a new #1 IRP based on data point analysis of the IRP performance, indication that a new #1 IRP has been selected because the previously identified #1 IRP has dropped coverage of a particular security, etc.

The “rating changes” subsection 560 may include various links associated with IRP rating change topics, e.g., selected IRP changed rating, short duration rating change (less than 5 days since previous rating change), inconsistent rating with the consensus rating, etc.

The “overrides” subsection 565 may include various links associated with override topics, e.g., all overrides, override IRP selected has dropped in ranking, override IRP selected improved in ranking, override no longer needed, etc.

The “reports” subsection 570 may include various links associated with reports produced by the independent research aggregation, analysis and delivery system, e.g., reports over 90 days old, etc.

The “overview” screen 500 also may include a “my searches” section 575 devoted to various operations and options for executing previously customized or personalized searches, i.e., searches formulated or formatted by the user himself. This section 575 may include a “my covered securities lists” subsection 580, which may include various links associated with topics relating to those securities included in the Client's universe, e.g., securities that currently have a rating of a buy or hold, securities for which a rating has been downgraded over the last week, securities having a rating that is more bullish than that indicated by the IRC's consensus indicator, etc. (see FIG. 14). The “overview” screen may also include other subsections including a “my IRP lists” subsection 585 that may include various links associated with the relative rankings of IRPs included in the Client representative's IRP pool based on data point analysis (explained herein), selection of those IRPs as primary IRPs for particular securities, etc. (see FIG. 14).

The “overview” screen 500 may also include a “security search” field 590, configured to allow a user to enter the symbol associated with a particular security, and a “search execute” icon 595, which when excited is configured to trigger execution of a search for information on the security associated with the symbol input in the field 590.

As explained above with reference to FIGS. 4 and 5, the front-end provided by the independent research aggregation, analysis and delivery system may also include a “coverage universe” screen, for which a link is provided on a menu included on the “overview” screen (as well as other screens included in the front-end, explained herein). The “coverage universe” screen 410 (illustrated in FIG. 4) is shown in greater detail as screen 600 in FIG. 6. The “coverage universe” screen is configured to display information associated with all of the securities included in a particular Client's coverage universe, i.e., each of the securities in a portfolio on which a Client is generating their own research and analysis and offering that research and analysis to their Customers and IRP data points, as they relate to the covered securities.

Like the “overview” screen, the “coverage universe” screen 600 may include a user-specific greeting and session information 605, which may include personalized information such as a welcome message referencing the user's name and/or user identification; this information may be available to the system as a result of the user being required to enter a user identification and password to gain access to and use of the independent research aggregation, analysis and delivery system as part of a login session.

The “coverage universe” screen 600 may also include a menu 610, which includes links to other screens included in the front-end. The menu includes an “overview” link 615, which, when excited, triggers display of the “overview” screen (an example of which being illustrated in FIG. 5). The menu 610 may also include a “coverage universe” link 620, which, when excited, triggers display of the “coverage universe” screen. Also included in the menu 610, are an “IRP list” link 625 (which, when excited, triggers display of an “IRP list” screen, an example of which being illustrated in FIG. 11), a “change history” link 630 (which, when excited, triggers display of an “change history” screen, an example of which being illustrated in FIG. 13), a “search” link 635 (which, when excited, triggers display of a “search” screen, an example of which being illustrated in FIG. 14), and a “preferences” link 640 (which, when excited, triggers display of a “preferences” screen, an example of which being illustrated in FIG. 15).

The “coverage universe” screen 600 may also display a list of all of the securities included in the Client's universe. This listing may include an entry for each security included in the universe; each entry may include an identification of the particular security 645 (including, for example, the security name and/or symbol), a “current” IRP section 650, “first alternate IRP” section 655 and “second alternate IRP” section 655. The IRP listed in the “current IRP” section 650 is the primary IRP associated with a particular security. In accordance with at least one embodiment of the invention, this primary IRP is the IRP whose independent research, upon transmission of that research from the IRP to the independent research aggregation, analysis and delivery system, may be sent to the Client and/or the Client's Customers in an automated manner.

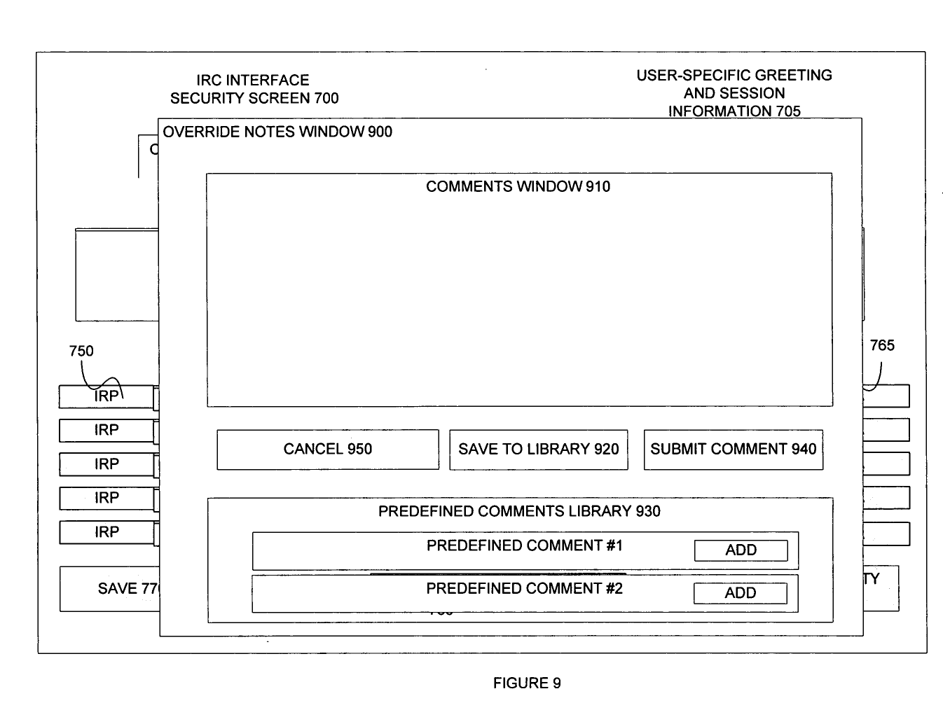

The “current IRP” section 650 generally includes information associated with the IRP that is presently ranked best at analyzing that security's value based on analysis of data points specified by the Client (explained herein); an exception to this general rule, is when the Client representative overrides this analysis and selects a particular IRP that he wishes to be the primary IRP for the listed security (as explained in association with FIG. 9). Each of these sections 645-655 may include for example, information identifying the particular IRP in that position, that IRP's current ranking, the rating, e.g., Buy, Sell, Hold, that the IRP has assigned to the security (and optionally, the period of time that rating has been in place), the IRP's batting average, i.e., an indication of prior analysis accuracy over a specified time period, the IRP's analysis style, e.g., quantitative, technical, fundamental or other, and the period of time since a report was submitted to the independent research aggregation, analysis and delivery system, etc. Thus, some or all of this information may be displayed on “coverage universe” screen 600 for each security included in the Client's universe.

The “coverage universe” screen 600 may also include icons that allow the user trigger generate an electronic mail message including the coverage list (“email coverage list” icon 665) or export the coverage list to another computer application (“export” icon 670).

The “coverage universe” screen 600 may also include a “security search” field 675, configured to allow a user to enter the symbol associated with a particular security, and a “search execute” icon 680, which when excited is configured to trigger execution of a search for information on the security associated with the symbol input in the field 675.

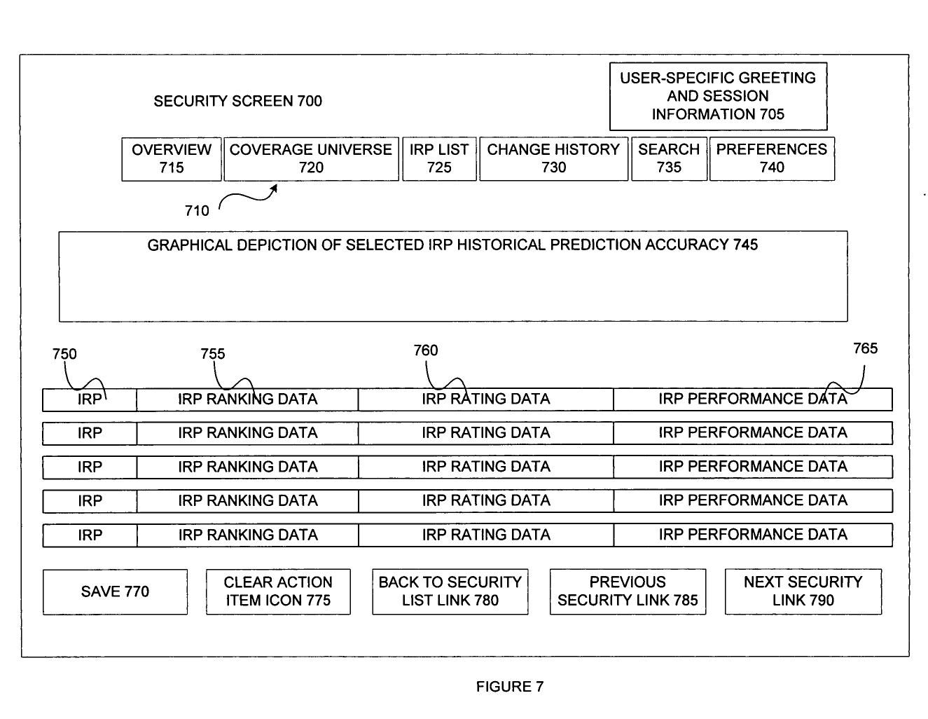

As explained above with reference to FIGS. 4 and 5, the front-end provided by the independent research aggregation, analysis and delivery system may also include a “security” screen, for which a link is provided on a menu included on the “overview” screen (as well as other screens included in the front-end, explained herein). The “security” screen 415 (illustrated in FIG. 4) is shown in greater detail as screen 700 in FIG. 7. Display of the “security” screen may triggered by any one of a number of actions by the user including, but not limited to, searching for a particular security using the “security search” field and “search execute” icons included on various screens included in the front-end, performing a search using one of the search action options included in the “quick searches” section 545 or “my searches” section 575 included on the “overview” screen 500 illustrated in FIG. 5, clicking on a particular security entry displayed on the “coverage universe” screen 600 illustrated in FIG. 6, etc.

Like the “overview” screen, the “security” screen 700 may include a user-specific greeting and session information 705, which may include personalized information such as a welcome message referencing the user's name and/or user identification; this information may be available to the system as a result of the user being required to enter a user identification and password to gain access to and use of the independent research aggregation, analysis and delivery system as part of a login session.

The “security” screen 700 may also include a menu 710, which includes links to other screens included in the front-end. The menu includes an “overview” link 715, which, when excited, triggers display of the “overview” screen (an example of which being illustrated in FIG. 5). The menu 710 may also include a “coverage universe” link 720, which, when excited, triggers display of the “coverage universe” screen (an example of which being illustrated in FIG. 6). Also included in the menu 710, are an “IRP list” link 725 (which, when excited, triggers display of an “IRP list” screen, an example of which being illustrated in FIG. 11), a “change history” link 730 (which, when excited, triggers display of an “change history” screen, an example of which being illustrated in FIG. 13), a “search” link 735 (which, when excited, triggers display of a “search” screen, an example of which being illustrated in FIG. 14), and a “preferences” link 740 (which, when excited, triggers display of a “preferences” screen, an example of which being illustrated in FIG. 15).

The “security” screen may include information associated with a particular security that may be of interest to a Client representative. For example, the “security” screen 700 may include a graphical depiction of the current IRP's historical prediction accuracy 745. Such a graphical depiction may graphically display the current IRP's predicted value of the security in comparison with the actual value of the security over a period of time, e.g., a quarter, half-year or full-year period. Additionally, that graphical depiction 745 may also include various numerical data including the deviation between the current IRP's predicted value and actual value over a particular time period and, optionally, the deviation between that actual value and a numerical indication of what the financial investment community or the IRP community as a whole predicted the value of the security would be. That graphical depiction 745 may also include a textual synopsis of the current IRP's present rating and a consensus indicator for that security. This consensus indicator may include a metric showing the average recommendation produced by aggregating all IRP recommendations on the security.

The “security” screen may also display a list of all of the IRPs who are generating independent research on the particular security (or alternatively may display a list of all IRPs included in the Client representative's IRP pool generating independent research on that security). This listing may include an entry for each IRP generating such research; each entry may include an identification of the particular IRP 750, IRP ranking data 755, IRP rating data and IRP performance data 765. Generally, the IRP listed in the first entry is the primary IRP associated with the security. In accordance with at least one embodiment of the invention, this primary IRP is the current IRP, that is, the IRP whose independent research may be automatically included in a Client-specific report that is sent to the Client and/or the Client's Customers in an automated manner.

The current IRP is generally the IRP that is presently ranked best at predicting the future behavior of that security's value based on analysis of data points specified by the Client (explained herein); an exception to this general rule, is when the Client representative overrides this analysis and selects a particular IRP that he wishes to be the primary IRP for the listed security (as explained in association with FIG. 9). Thus, each entry may also include IRP ranking data 755, which indicates the ranking of the IRP based on analysis of data points specified by the Client. The listing of entries may also include other indicia that a Client representative has overridden the ranking of the IRPs and selected an alternative IRP to be the current IRP for the security, e.g., shading, highlighting, etc.

Each entry may also include IRP rating data 760 that indicates the rating that the particular IRP has assigned to the security. This rating data 760 may include a current recommendation, the number of days that recommendations has been made as well as the average days held, i.e., how long the recommendation has been held.

Each entry may also include IRP performance data 765, which may include a numerical and/or graphical indication of the particular IRP's performance at accurately predicting the value of the security, the analytic style of the IRP (e.g., qualitative, technical or other) and, optionally, an icon, which when excited, may trigger display of a graphical depiction of the IRP's historical prediction accuracy (either in the graphical depiction 745 or in a pop-up window).

The “security” screen 700 allows the user to make changes to the ranking of the IRPs by, for example, exciting an IRP's entry, to change the prioritization associated with a particular IRP. Thus, the “security” screen 700 may also include a “save” icon 770, which allows a user to save changes made by the user and stop viewing the security data, and a “clear action item” icon 775, which allows a user to clear selection of a previously selected item from a selection list.

Additionally, the “security” screen 700 may include various links that allow a Client representative to view security data associated with other securities included in the Client's universe. Such links may include, for example, a “back to security list” link 780, which when excited may trigger display of a previously displayed “coverage universe” screen (an example of which being illustrated in FIG. 6) or search results generated as a result of executing a search utilizing one of various search tools provided by the independent research aggregation, analysis and delivery system. Such links may also include a “previous security” link 785 and a “next security” link 790, which, when excited, respectively trigger display of a previous or next security listed in the Client's security coverage universe (e.g., the list displayed on the “coverage universe” screen 600 illustrated in FIG. 6).

As explained above, a Client representative may select data points to be analyzed when determining which IRP included in the IRP pool is the primary (or current) IRP associated with a particular security. It should be understood that, in accordance with at least one embodiment of the invention, once the Client representative selects a set of data points to be analyzed, those data points are analyzed when determining the primary IRP for each security in the Client's coverage universe. That is, all of the IRPs' performances are analyzed based on the same data points, i.e., analysis criteria, for each security in the Client's coverage universe. Therefore, although such analysis may yield a different primary IRP for each security included in the Client's coverage universe, the analysis for all IRPs reviews the same data points.

Nevertheless, it should be understood that, in accordance with at least one other embodiment of the invention, a Client representative may select different data points to be analyzed for each security listed in the Client's coverage universe; however, it should be understood that such a configuration significantly increases the complexity of the front-end and associated software supporting that front-end and populating the supplementary database included in the independent research aggregation, analysis and delivery system.

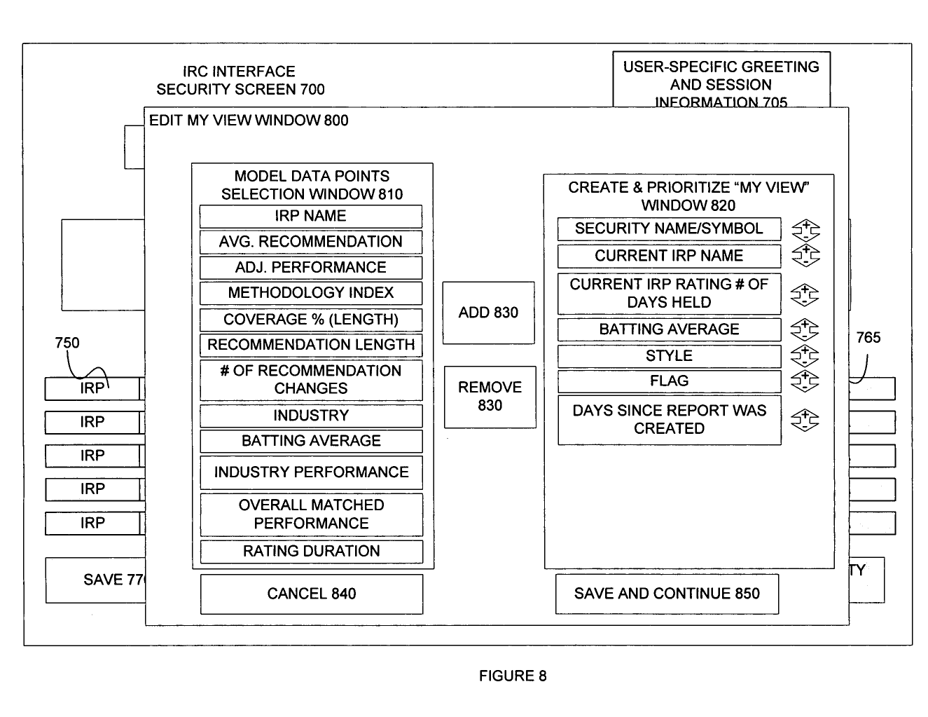

Both at the outset of establishing delivery of the independent research to a Client and on an ongoing basis (periodically, e.g., monthly or quarterly, and/or, spontaneously) the Client representative and/or IRC personnel may review the research generated by various IRPs, those included in the Client representative's IRP pool and, in particular, the primary IRPs associated with the securities included in the Client's coverage universe, to determine whether adjustments should be made. As part of this review and adjustment, a Client representative may specify one or more data points that may be analyzed by the independent research aggregation, analysis and delivery system to help determine which IRPs are selected as primary IRPs for securities included in the Client's coverage universe. In order to set the data points to be analyzed when determining primary IRPs for securities included in a Client's coverage window, a Client representative may input selections for data points using the “edit my view” window. The “edit my view” window 420 (illustrated in FIG. 4) is shown in greater detail as window 800 in FIG. 8.

Display of the “edit my view” window may be triggered by, for example, a user exciting an “edit my view” icon that may be included on any of the screens included in the front-end. As illustrated in FIG. 8, the “edit my view” window 800 may include a “model data points selection” window 810 that includes a list of model data points, which may be selected by the user to be reviewed when determining which IRPs will be the primary IRPs for securities included in the Client's coverage universe. Such model data points may include, for example, an IRP name, average recommendation issued by the IRP, adjusted performance (e.g., a statistical metric representing correlation between previous recommendations and subsequent movements in securities price), methodology index (e.g., type of research: fundamentally or quantitatively driven or otherwise), coverage % (length) (e.g., IRP's coverage as it relates to the Client's coverage universe), recommendation length (e.g., length of time that an IRP has held a particular recommendation), number of recommendation changes (e.g., number of recommendation changes over a specified period), industry, batting average, portfolio performance (e.g., summary performance of the constituent securities), and duration that a rating (i.e., buy, sell, hold, etc.) has been in place. A user may add or remove these model data points by, for example, highlighting one or more data points and exciting the “add” icon 830 or the “remove” icon 840, respectively.

Additionally, a user may prioritize the selected data points using various options available in a “create and prioritize my view” window 820. Within that window, various subsections associated with selected data points are listed along with some mechanism for prioritizing the selected data points, e.g., a dual headed arrow associated with each selected data point, that, when excited may trigger adjustment (either positive or negative) of the relative priority associated with that particular data point (relative to other selected data points). If, following input of changes to the data points, the user elects not to implement the changes, the user may excite the “cancel” icon 840, which may trigger resetting the contents of the window 800 to correspond with what had previously been saved. Alternatively, if the user elects to implement the changes, the user may excite the “save and continue” icon 850, which may trigger saving of the changes input by the user.

Once a user, e.g., a Client representative, has selected and prioritized data points to be used when identifying which IRP's research will be included in automated Client-specific reports, such reports may be retrieved from the system and transmitted to the Client and, optionally, Client Customers in an automated manner, i.e., without requiring additional input on the part of the user. A Client-specific report may not include analysis and research generated by more than one IRP; rather, each research product generated by an IRP may be the subject of its own Client-specific report. It should be understood that, in accordance with at least one embodiment of the invention, only a subset of the IRPs in a Client representative's IRP pool, for example, only a highest ranked IRP (relative to the other IRPs included in the Client representative's IRP pool based on data point analysis) may be generating research that is automatically included in Client-specific reports and transmitted to the Client and/or its Customers for a particular security.

In accordance with at least one embodiment of the invention, depending on the instructions of the Client's representative, the Client's representative may use the system to automatically forward more then one Client-specific report for a particular security generated by more then one IRP; such a situation may occur when, for example, the Client representative has concluded that the research generated by one IRP is quite valuable, whereas the research generated by another IRP should be disclosed to Client Customers in the interest of candor.

Moreover, in accordance with at least the first embodiment of the invention, the terms of the Settlement may require that the Client representative, i.e., the IC, contract with at least three IRPs to provide independent research. Thus, these at least three IRPs' research is accessible by the IC; from that research, the IC is required to select at least one IRP whose research is automatically forwarded to the Client and its Customers via the independent research aggregation, analysis and delivery system. the IRPs generate that research.

Thus, in accordance with the at least the first embodiment, the determination of whether to include a particular IRP's research in a Client-specific report for a particular security is based entirely on the instructions of the Client representative, in particular, the data points and the preferences set by the Client representative. Thus, the generation and automated delivery of Client-specific reports may be based on ranking of the IRPs included in the IRP pool and associated with a particular security.

Therefore, it would be reasonable to presume that an IRP's historical performance of predicting the value of a particular security may be an accurate indication of that IRP's knowledge of that security; thus, a Client representative may select, as a data point, an indicator of this performance. As a result, when that IRP's historical performance surpasses that of some or all of the other IRPs included in the IRP pool for that particular security, the system may be configured to automatically re-rank the IRPs based on the change and, potentially, select that IRP as the primary IRP for that security. Thus, without requiring additional instruction from the Client representative, the independent research aggregation, analysis and delivery system may automatically include that particular IRP's research into a Client-specific report and transmit that report to the Client and/or the Client's Customers. Alternatively, the independent research aggregation, analysis and delivery system may automatically generate a notification to the Client representative indicating that a new primary IRP has been selected based on the Client's data points.

Thus, although various IRPs may be included in a Client representative's IRP pool, the generation and automated delivery of Client-specific reports including IRP research may be subject to criteria, i.e., data points, specified by the Client representative, which is subject to alteration at any time by the Client representative.

Accordingly, from the point that the Client representative selects data points, the independent research aggregation, analysis and delivery system may select one or more IRPs that will provide independent research on a particular security and all future research products uploaded by the IRP(s) to the IRC's primary database on that security may be automatically stored in the supplemental database and (depending on the Client representative's directions) also transmitted to the Client and the Client's Customers in Client-specific reports unless the Client representative transmits a request, through the independent research aggregation, analysis and delivery system, to terminate delivery of the independent research from that particular IRP for that security or, based on analysis of the selected data points, the particular IRP(s) no longer is ranked as the primary IRP for that security. The Client may receive these reports in an electronic format and may distribute the reports, in paper copy or in a secure electronic format, to its retail and institutional customers.

In accordance with at least one embodiment of the invention, the IRC and the Client's representative may, at any time, also evaluate a current Client-specific report style and format of a plurality of chosen IRPs' research to discern if enhancements to the reports may be made. Should any customization of reports be deemed advantageous, the IRC may work with the Client representative and the IRPs to create a workable report solution that meets the needs of the Client. Additionally, the IRC may provide customized research report styles for the analysis of various IRPs.

Although one useful feature of the independent research aggregation, analysis and delivery system is the ability to automate both the selection and transmission of independent research to a Client and Client Customers, as mentioned above, the system may also be configured to allow a user, e.g., a Client Representative, to override the system's selection of the primary IRP(s) for a particular security. Such a situation may occur, for example, if the Client representative has reason to believe that a particular IRP's research, which based on data point analysis is indicated to be the most accurate, is in fact suspect or deficient in some way. However, the Client representative may need or want to have some mechanism for recording information associated with such a determination. Thus, the independent research aggregation, analysis and delivery system may include an “override notes” window (as explained above briefly with reference with reference to FIG. 4). That “override notes” window 425 (illustrated in FIG. 4) is shown in greater detail as window 900 in FIG. 9.

Display of the “override notes” window may be triggered by a user, e.g., the Client representative, overriding the automated selection of a particular IRP as the primary IRP for a particular security. This override instruction may be input to the system using one of the GUIs provided in the front-end, for example, by a user exciting an entry for a particular security while viewing the “coverage universe” screen, which may trigger display of a list of all IRPs in the Client representative's IRP pool who are reporting on that security. Alternatively, a user may excite a particular entry associated with a particular IRP reporting on a security while the user is viewing the “security” screen, and then “dragging” that IRP entry to a different relative position in a listing of IRPs, which may trigger selection of that IRP as the primary IRP for that security. Additionally, it should be understood that other actions may be performed by a user to trigger overriding the automated selection of a primary IRP for a particular security.

Regardless of the mechanism for triggering display of the “override notes” window, the “override notes” window 900 may include a “comments” window 910, in which the user, e.g., the Client representative, may record information associated with, for example, the user's rationale for instituting the override, individuals involved in making the decision to institute the override, etc. Alternatively, the system may, optionally, be configured to also provide a predefined comments library 930 that may include various comments that would likely be the text included in the “comments” window 910, from which the user may select by exciting an “add” icon associated with a particular comment that the user wishes to include in that window. If the user would like to add a new comment to the predefined comments library 930, the user may simply enter text in the “comments” window 910 and excite the “save to library” icon 920. Following entry of comments in the window 910, the user may then excite the “submit comment” icon 940 to save the comments included in the “comments” window 910 in association with the override that the user is instituting; alternatively, if the user would like to cancel the comments, the user may simply excite the “cancel” icon 950.

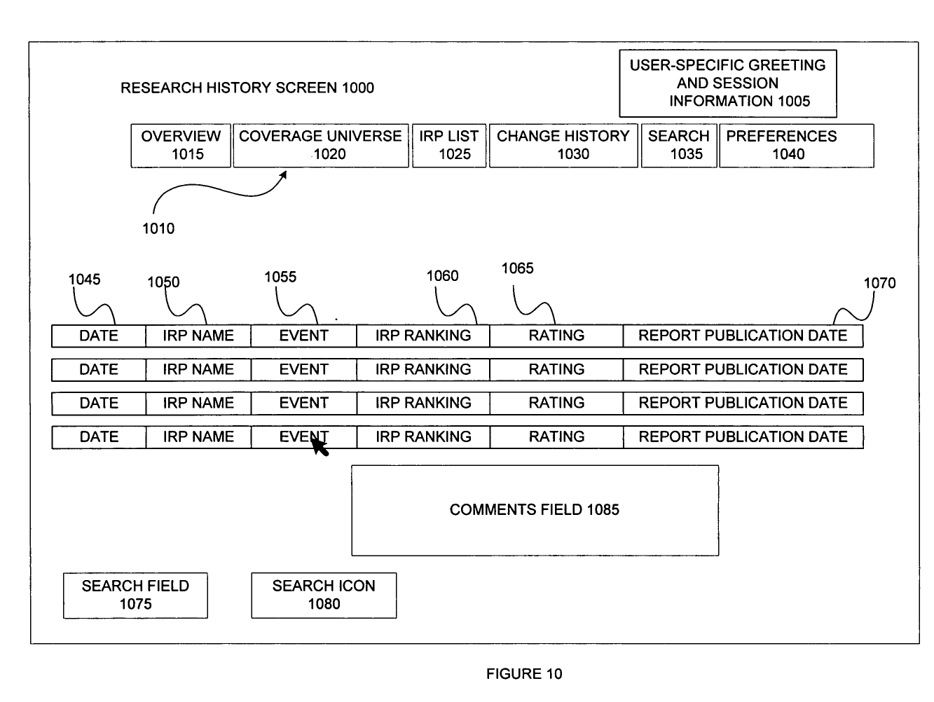

As explained above with reference to FIGS. 4 and 5, the front-end provided by the independent research aggregation, analysis and delivery system may also include a “security research history” screen, for which a link is provided on a menu included on the “overview” screen (as well as other screens included in the front-end, explained herein). The “security research history” screen 430 (illustrated in FIG. 4) is shown in greater detail as window 1000 in FIG. 10.

Like the “overview” screen, the “security research history” screen 1000 may include a user-specific greeting and session information 1005, which may include personalized information such as a welcome message referencing the user's name and/or user identification; this information may be available to the system as a result of the user being required to enter a user identification and password to gain access to and use of the independent research aggregation, analysis and delivery system as part of a login session.

The “security research history” screen 1000 may also include a menu 1010, which includes links to other screens included in the front-end. The menu includes an “overview” link 1015, which, when excited, triggers display of the “overview” screen (an example of which being illustrated in FIG. 5). The menu 1010 may also include a “coverage universe” link 1020, which, when excited, triggers display of the “coverage universe” screen (an example of which being illustrated in FIG. 6). Also included in the menu 1010, are an “IRP list” link 1025 (which, when excited, triggers display of an “IRP list” screen, an example of which being illustrated in FIG. 11), a “change history” link 1030 (which, when excited, triggers display of an “change history” screen, an example of which being illustrated in FIG. 13), a “search” link 1035 (which, when excited, triggers display of a “search” screen, an example of which being illustrated in FIG. 14), and a “preferences” link 1040 (which, when excited, triggers display of a “preferences” screen, an example of which being illustrated in FIG. 15).

The “security research history” screen 1000 pertains to the events that have occurred historically in relationship to the selection of one or more IRPs as the primary IRP providing independent research to a Client for a particular security. As a result, the “security research history” screen 1000 may include various entries associated with events included in that history including but not limited to, selection of a new primary IRP as a result of the primary IRP dropping coverage of the security, i.e., electing not to generate independent research on that security over a certain period of time (e.g., one or more quarters), selection of a new primary IRP as a result of re-ranking of the IRPs in the Client representative's IRP pool based on the Client's data points and those IRPs relative performance in predicting the value of the security, re-ranking of any of the IRPs included in the Client representative's IRP pool based on such a change in relative performance, issuance of a new independent research report by the primary IRP and/or any IRP included in the Client representative's IRP pool, overrides input by the Client representative, etc. Within the listing of entries displayed on the research history screen 1000, the entries may be displayed for a particular period e.g., on a monthly basis.

Within the listing, each entry may include a date 1045 of the event, an IRP name 1050 identifying the IRP involved in the event, information 1055 indicating the nature of the event (e.g., drop in coverage, re-ranking, issuance of a report, input of an override, etc.) Optionally, the system may be configured to display comments (such as those input in association with the override comments window, an example of which being illustrated in FIG. 9) associated with the event when a user uses a pointing device, e.g., a mouse, to hover a curser on the screen over the event entry. Each entry may also include an icon, which may be excited by the user to trigger display of the IRP's most recent independent research report. Each entry may also include the IRP's ranking 1060, which may include the current ranking as well the previous ranking, as well as the security rating 1065 that the IRP has presently assigned to the security (e.g., buy, hold, sell) and the period of time that rating has been assigned. Each entry may also include the publish date 1070 of the identified IRP's (identified at 1050) most recent report.

The “security research history” screen 1000 may also include a “security search” field 1075, configured to allow a user to enter a keyword or date associated with a particular historic record, and a “search execute” icon 1080, which when excited is configured to trigger execution of a search for information associated with the input in the field 1075.

As explained above with reference to FIGS. 4 and 5, the front-end provided by the independent research aggregation, analysis and delivery system may also include an “IRP list” screen, for which a link is provided on a menu included on the “overview” screen (as well as other screens included in the front-end, explained herein). The “IRP list” screen 435 (illustrated in FIG. 4) is shown in greater detail as window 1100 in FIG. 11. The “IRP list” screen may be configured to include a list of all of the IRPs included in a Client representative's IRP pool, all IRPs generating independent research that is available through the independent research aggregation, analysis, and delivery system (using the select universe field 1192, explained herein).

Like the “overview” screen, the “IRP list” screen 1100 may include a user-specific greeting and session information 1105, which may include personalized information such as a welcome message referencing the user's name and/or user identification; this information may be available to the system as a result of the user being required to enter a user identification and password to gain access to and use of the independent research aggregation, analysis and delivery system as part of a login session.

The “IRP list” screen 1100 may also include a menu 1110, which includes links to other screens included in the front-end. The menu includes an “overview” link 1115, which, when excited, triggers display of the “overview” screen (an example of which being illustrated in FIG. 5). The menu 1110 may also include a “coverage universe” link 1120, which, when excited, triggers display of the “coverage universe” screen (an example of which being illustrated in FIG. 6). Also included in the menu 1110, are an “IRP list” link 1125 (which, when excited, triggers display of the “IRP list” screen), a “change history” link 1130 (which, when excited, triggers display of an “change history” screen, an example of which being illustrated in FIG. 13), a “search” link 1135 (which, when excited, triggers display of a “search” screen, an example of which being illustrated in FIG. 14), and a “preferences” link 1040 (which, when excited, triggers display of a “preferences” screen, an example of which being illustrated in FIG. 15).

As illustrated in FIG. 11, the “IRP list” screen may be configured to display a listing of entries, each associated with a particular IRP. Thus, each entry may include various pieces of information associated with that IRP. For example, each entry may include a flag 1145 indicating whether the IRP listed in the IRP name 1150 has been designated as an A or B-list IRP by the Client representative. An A or B list is an example of a grading scale, e.g., the Client representative would prefer IRPs that are A listed, if given the choice between and “A List” or “B List” IRP. Each entry may also include the named IRP's ranking 1155 (optionally including its present and previous ranking), a number of times 1160 that the named IRP has been selected as a primary IRP for a particular security for the Client, the batting average 1165 of the IRP, the number of securities covered (i.e., number of securities on which the IRP provides independent research) 1170, the average holding duration 1175 (i.e., a holding period), average rating assigned by the IRP 1185 (this may include a percentage breakdown of the securities assigned various ratings), an indicia of the IRP's portfolio performance 1182, which may be calculated using various statistical methods, and an indication of the analytical style of the IRP 1184, e.g., quantitative, technical, fundamental, or other.

The user, e.g., Client representative, may make changes to the IRP listing, e.g., changing an IRP's status with regard to the flag and, subsequently, save these changes by exciting the “save” icon 1186. Additionally, the user may trigger export the displayed IRP list, e.g., sending the displayed IRP list via electronic-mail or export the list to another computer application by exciting the “IRP list export” icon 1188. Optionally, the system may be configured to display a description summary 1190 of an IRP when a user uses a pointing device, e.g., a mouse, to hover a curser on the screen over the IRP entry. Additionally, as explained above, the user may select the universe of IRPs to be displayed, e.g., the IRPs included in the Client representative's IRP pool or all IRPs contributing independent research to the IRC, by selecting such a universe using the “select universe” field 1192. It should also be understood that such a select universe field may be included on other screens included in the front-end. Moreover, the user may trigger the “edit my view” window (allowing the user to select data points used when determining a primary IRP for a particular security and allowing the user to prioritize those data points), an example of which being illustrated in FIG. 8 and explained above, by exciting an “edit my view” icon 1194 included in the “IRP list” screen.

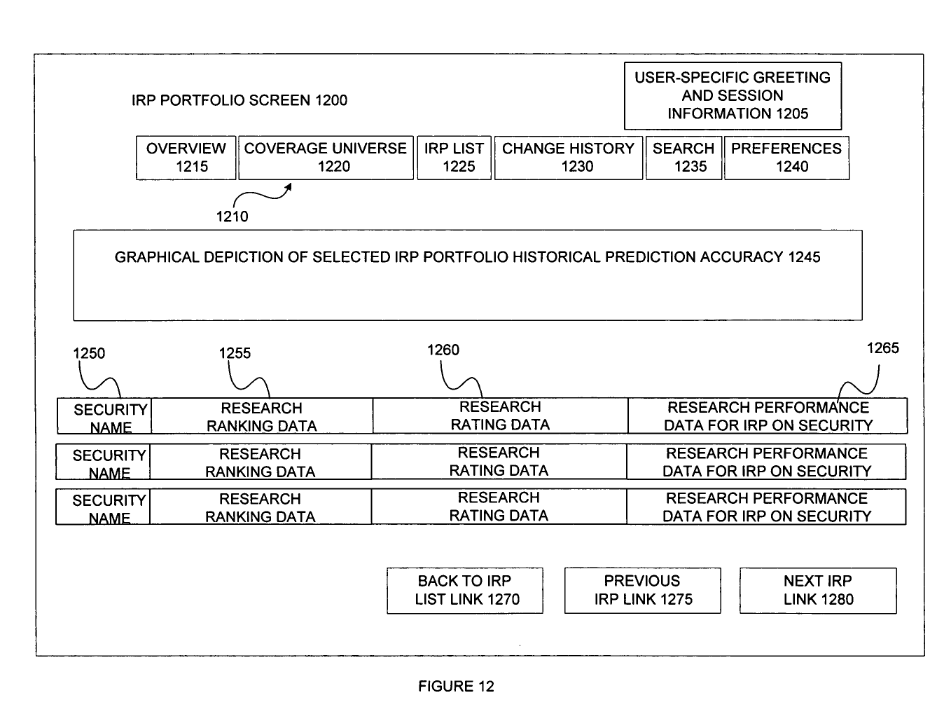

As explained above with reference to FIGS. 4 and 5, the front-end provided by the independent research aggregation, analysis and delivery system may also include an “IRP portfolio” screen, for which a link is provided on a menu included on the “overview” screen (as well as other screens included in the front-end, explained herein). The “IRP portfolio” screen may include more detailed information associated with a portfolio of an IRP. Display of the “IRP portfolio” screen may be triggered by selecting a listing entry associated with a particular IRP included on the “IRP list” screen (see FIG. 11) The “IRP portfolio” screen 440 (illustrated in FIG. 4) is shown in greater detail as window 1200 in FIG. 12.

Like the “overview” screen, the “IRP portfolio” screen 1200 may include a user-specific greeting and session information 1205, which may include personalized information such as a welcome message referencing the user's name and/or user identification; this information may be available to the system as a result of the user being required to enter a user identification and password to gain access to and use of the independent research aggregation, analysis and delivery system as part of a login session.

The “IRP portfolio” screen 1200 may also include a menu 1210, which includes links to other screens included in the front-end. The menu includes an “overview” link 1215, which, when excited, triggers display of the “overview” screen (an example of which being illustrated in FIG. 5). The menu 1210 may also include a “coverage universe” link 1220, which, when excited, triggers display of the “coverage universe” screen (an example of which being illustrated in FIG. 6). Also included in the menu 1210, are an “IRP list” link 1225 (which, when excited, triggers display of an “IRP list” screen, an example of which being illustrated in FIG. 11), a “change history” link 1230 (which, when excited, triggers display of an “change history” screen, an example of which being illustrated in FIG. 13), a “search” link 1235 (which, when excited, triggers display of a “search” screen, an example of which being illustrated in FIG. 14), and a “preferences” link 1240 (which, when excited, triggers display of a “preferences” screen, an example of which being illustrated in FIG. 15).

The “IRP portfolio” screen may also include a graphical depiction of the selected IRP's portfolio historical prediction accuracy 1245; this graphical depiction 1245 may include a section which pertains to the Client's coverage universe and a section that pertains to the IRP's portfolio. Thus, the graphical depiction 1245 may allow a user to review the IRP's performance in both areas to determine how accurate the IRP has been in its predictions. Additionally, the graphical depiction 1245 may include textual information indication accuracy indicators, the total number of securities in the Client's universe, the total number of securities in the IRP's portfolio, etc.

The “IRP portfolio” screen may also include a listing of entries, each pertaining to a security included in the IRP's portfolio of securities on which the IRP generates independent research. Each entry may include the security name 1250 as well as research ranking data 1255, which may indicate the current ranking of that IRP for the listed security (as well as, optionally, the most recent previous ranking of that IRP for the list security as well). Similarly, each entry may include research rating data 1260, which may indicate the current rating assigned to the listed security by that IRP (as well as, optionally, the period of time that the IRP has held the current research rating). Also, each entry may include a research performance data 1265 for the IRP on the listed security, e.g., a graphical representation and/or numerical indicators.

The “IRP portfolio” screen 1200 may also include a back to “IRP list” link 1270 that, when excited by a user, will trigger re-display of the “IRP list” screen (an example of which being illustrated in FIG. 11), as well as a “previous IRP” link 1275 and a “next IRP” link 1280 that respectively trigger display of the “IRP portfolio” screen including data particular to a previous IRP and next IRP listed on that “IRP list” screen (see FIG. 11).

As explained above with reference to FIGS. 4 and 5, the front-end provided by the independent research aggregation, analysis and delivery system may also include a “change history” screen, for which a link is provided on a menu included on the “overview” screen (as well as other screens included in the front-end, explained herein). The “change history” screen 445 (illustrated in FIG. 4) is shown in greater detail as window 1300 in FIG. 13.

Like the “overview” screen, the “change history” screen 1300 may include a user-specific greeting and session information 1305, which may include personalized information such as a welcome message referencing the user's name and/or user identification; this information may be available to the system as a result of the user being required to enter a user identification and password to gain access to and use of the independent research aggregation, analysis and delivery system as part of a login session.

The “change history” screen 1300 may also include a menu 1310, which includes links to other screens included in the front-end. The menu includes an “overview” link 1315, which, when excited, triggers display of the “overview” screen (an example of which being illustrated in FIG. 5). The menu 1310 may also include a “coverage universe” link 1320, which, when excited, triggers display of the “coverage universe” screen (an example of which being illustrated in FIG. 6). Also included in the menu 1310, are an “IRP list” link 1325 (which, when excited, triggers display of an “IRP list” screen, an example of which being illustrated in FIG. 11), a “change history” link 1330 (which, when excited, triggers display of an “change history” screen, an example of which being illustrated in FIG. 13), a “search” link 1335 (which, when excited, triggers display of a “search” screen, an example of which being illustrated in FIG. 14), and a “preferences” link 1340 (which, when excited, triggers display of a “preferences” screen, an example of which being illustrated in FIG. 15).

The “change history” screen may be configured to include a list of entries, each being associated with a change in the selection of a primary IRP associated with a security included in the Client's portfolio. This listing of entries may be provided for a particular period of time for example, for a particular month and year such as the current month and year. Accordingly, each entry in the listing may include a date associated with the change, the security involved 1350, the new primary IRP 1355 selected as a result of the change, a “comment” field 1360 that includes the reason for the change, an average rating 1365 issued by the new primary IRP for that security and a report publish date 1370 (which is the date that the new primary IRP issued its last independent research report on the named security).

The “change history” screen 1300 may also include a “security search” field 1375, configured to allow a user to enter the symbol associated with a particular security, and a “search execute” icon 1380, which when excited is configured to trigger execution of a search for information on the security associated with the symbol input in the field 175.

As explained above with reference to FIGS. 4 and 5, the front-end provided by the independent research aggregation, analysis and delivery system may also include a “search” screen, for which a link is provided on a menu included on the “overview” screen (as well as other screens included in the front-end, explained herein). The “search” screen 450 (illustrated in FIG. 4) is shown in greater detail as window 1400 in FIG. 14.

Like the “overview” screen, the “search” screen 1400 may include a user-specific greeting and session information 1405, which may include personalized information such as a welcome message referencing the user's name and/or user identification; this information may be available to the system as a result of the user being required to enter a user identification and password to gain access to and use of the independent research aggregation, analysis and delivery system as part of a login session.

The “search” screen 1400 may also include a menu 1410, which includes links to other screens included in the front-end. The menu includes an “overview” link 1415, which, when excited, triggers display of the “overview” screen (an example of which being illustrated in FIG. 5). The menu 1410 may also include a “coverage universe” link 1420, which, when excited, triggers display of the “coverage universe” screen (an example of which being illustrated in FIG. 6). Also included in the menu 1410, are an “IRP list” link 1425 (which, when excited, triggers display of an “IRP list” screen, an example of which being illustrated in FIG. 11), a “change history” link 1430 (which, when excited, triggers display of an “change history” screen, an example of which being illustrated in FIG. 13), a “search” link 1435 (which, when excited, triggers display of the “search” screen), and a “preferences” link 1440 (which, when excited, triggers display of a “preferences” screen, an example of which being illustrated in FIG. 15).

The “search” screen may be configured to generate, execute and save searches for a user. For example, the screen may include a “covered security search criteria” section 1445 that includes subsections associated with certain specified search criteria 1450, potential values 1455 for those criteria and a period of time 1460 over which a search should be performed. Using these subsections, a user may search information included in the databases of the independent research aggregation, analysis and delivery system for, for example, a situation when trading volume for a security has risen or fallen, a security was added or dropped from the Client's coverage universe, a security has a particular rating (based on the primary IRP's analysis and/or from the consensus indicator), a security's rating has been upgraded or downgraded, a primary IRP's rating is more bullish or bearish then the corresponding consensus indicator, etc. These searches may, based on the search criteria included in the search period subsection 1460, be performed for such situations that have occurred, for example, over the last week, two weeks, month quarter, half year, year, etc. Using the covered security search criteria section and the included subsections, the user can generate and execute custom searches. The user can also associate each custom search with a search name by entering that name in the “save search” field 1465 and exciting the “save” icon 1470.

Subsequently, these custom searches may be available and utilized by a user from the “my searches” section under the “my covered securities lists” searches on the “overview” screen (an example of which being illustrated in FIG. 5) is displayed.

Similarly, the screen may also include an “IRP list search criteria” section 1475 that includes subsections associated with certain specified search criteria 1480, potential values 1485 for those criteria and a period of time 1490 over which a search should be performed. Using these subsections, a user may search information included in the databases of the independent research aggregation, analysis and delivery system for, for example, a situation when IRPs included in the Client representative's IRP pool have been dropped or added, a primary IRP has dropped or added coverage for a security, an IRP included in the Client representative's IRP pool has added or dropped coverage of a security, an IRP has become the most selected to be a primary IRP by the Client based on data point analysis or a new IRP has been selected as a primary IRP for a security, an IRP ranking has risen or fallen, an IRP is a primary IRP or was the primary IRP, a primary IRP is or was ranked best based on data point analysis, a primary IRP's rating has risen or fallen, etc. These searches may, based on the search criteria included in the “search period” subsection 1490, be performed for such situations that have occurred, for example, over the last week, two weeks, month quarter, half year, year, etc. Using the covered security search criteria section and the included subsections, the user can generate and execute custom searches. The user can also associate each custom search with a search name by entering that name in the “save search” field 1492 and exciting the “save” icon 1494.

Subsequently, these custom searches may be available and utilized by a user from the “my searches section” under the “my IRP lists searches” on the “overview” screen (an example of which being illustrated in FIG. 5) is displayed.

The “search” screen 1400 may also include a “security search” field 1496, configured to allow a user to enter the symbol associated with a particular security, and a “search execute” icon 1498, which when excited is configured to trigger execution of a search for information on the security associated with the symbol input in the field 1496.

As explained above with reference to FIGS. 4 and 5, the front-end provided by the independent research aggregation, analysis and delivery system may also include a “preferences” screen, for which a link is provided on a menu included on the “overview” screen (as well as other screens included in the front-end, explained herein). The “preferences” screen may be configured to allow the user, e.g., the Client representative, to customize various options and automated actions with regard to selection of primary IRPs for securities based on certain specified events. The “preferences” screen 455 (illustrated in FIG. 4) is shown in greater detail as window 1500 in FIG. 15.

Like the “overview” screen, the “preferences” screen 1500 may include a user-specific greeting and session information 1505, which may include personalized information such as a welcome message referencing the user's name and/or user identification; this information may be available to the system as a result of the user being required to enter a user identification and password to gain access to and use of the independent research aggregation, analysis and delivery system as part of a login session.

The “preferences” screen 1500 may also include a menu 1510, which includes links to other screens included in the front-end. The menu includes an “overview” link 1515, which, when excited, triggers display of the “overview” screen (an example of which being illustrated in FIG. 5). The menu 1510 may also include a “coverage universe” link 1520, which, when excited, triggers display of the “coverage universe” screen (an example of which being illustrated in FIG. 6). Also included in the menu 1510, are an “IRP list” link 1025 (which, when excited, triggers display of an “IRP list” screen, an example of which being illustrated in FIG. 11), a “change history” link 1530 (which, when excited, triggers display of an “change history” screen, an example of which being illustrated in FIG. 13), a “search” link 1535 (which, when excited, triggers display of a “search” screen, an example of which being illustrated in FIG. 14), and a “preferences” link 1540 (which, when excited, triggers display of an “preferences” screen).

The “preferences” screen may include a “preferences options” section 1545 that includes a number of subsections offering various options acceptable by a user by the exciting a box next to a particular option to set a flag for that option. These subsections may include a subsection 1550 associated with initiation of coverage options; in this section, various options may be included, for example, automatically defaulting to an IRP that has been ranked best at accurately predicting a security's value (based on data point analysis) as the primary IRP for that security when initiating coverage for that security. These subsections may also include a subsection 1555 associated with the options situation when a primary IRP drops coverage for a security; such subsection may include various options, for example, automatically defaulting to an IRP that is presently covering the security (i.e., generating independent research on that security) and ranked best at accurately predicting that security's value (based on data point analysis) as the primary IRP for that security when the previously selected primary IRP drops coverage for the security (i.e., elects not to generate independent research for that security). The section 1545 may also include a subsection 1560 associated with options when a primary IRP for a particular security falls in relative rank in comparison to other IRPs included in the Client representative's pool and generating research on that security; such a subsection may include options, for example, again, automatically defaulting to an IRP that is presently covering the security (i.e., generating independent research on that security) and ranked best at accurately predicting that security's value (based on data point analysis) as the primary IRP for that security when the previously selected primary IRP drops coverage for the security (i.e., elects not to generate independent research for that security). Other options, and option sections may also be included, as would be understood by one of ordinary skill in the art.

The “preferences” screen 1500 may also include a “security search” field 1565, configured to allow a user to enter the symbol associated with a particular security, and a “search execute” icon 1570, which when excited is configured to trigger execution of a search for information on the security associated with the symbol input in the field 1565.

While this invention has been described in conjunction with the specific embodiments outlines above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, it should be understood that a system designed in accordance with at least one embodiment of the invention may include a supplemental database that, rather then including somewhat duplicative entries to that included in the primary database, may actually include entries associated with a particular Client, an indication of what IRPs are included in an associated Client representative's IRP pool, an indication of the data points selected by the Client representative, the relative weight of the data points when determining primary IRPs for covered securities, mapping/links to the IRPs research included in the primary database, etc.

1. A system for enabling access to, analysis of and automated delivery of independent research relating to a plurality of securities provided by a plurality of independent research providers, the system comprising:
a front-end including at least one graphical user interface that is configured to receive instructions from a Client representative, the instructions including at least one data point to be used when selecting at least one independent research provider to deliver independent research on at least one security to the Client via the system; and
a controller configured to automatically select the at least one independent research provider based on the at least one data point and control automated delivery of such independent research in a Client-specific report to the Client in response to the system receiving such independent research from the selected independent research provider.

2. The system of claim 1, wherein the Client representative is an independent consultant hired by the Client in accordance with the Global Research Analyst Settlement announced on Apr. 28, 2003 by the Securities and Exchange Commission of the U.S. Government.

3. The system of claim 2, the controller is configured to control automated delivery of independent research generated by at least one independent research provider selected by the Client representative to the Client in response to the system receiving such independent research from the selected independent research provider.

4. The system of claim 1, wherein the Client representative is personnel of the Client.

5. The system of claim 1, wherein the Client representative is a director of research for the Client.

6. The system of claim 1, wherein the Client is a securities brokerage firm or investment firm.

7. The system of claim 1, wherein the controller is also configured to control automated delivery of such independent research in a Client-specific report to the Client's Customers in response to the system receiving such independent research from the selected independent research provider.

8. The system of claim 1, wherein the controller is configured to select the at least one independent research provider based on a plurality of data points received from the Client representative.

9. The system of claim 1, wherein the controller is configured to select at least one independent research provider for each security included in a Client's coverage universe based on the at least one data point.

10. The system of claim 1, wherein the controller is configured to automatically select a new independent research provider based on the at least one data point when data associated with that at least one data point indicates that the Client representative would prefer selection of a new independent research provider, and, wherein the instructions from the Client representative include at least one preference indicating when the Client representative would prefer selection of a new independent research provider.

11. The system of claim 10, wherein the at least one preference includes an instruction to automatically select an independent research provider that, based on analysis performed by the controller using the at least one data point, is ranked as best at predicting a future value of the security from among a number of independent research providers included in a Client-specific independent research provider pool.

12. The system of claim 10, wherein the at least one preference includes an instruction to automatically select an independent research provider that, based on analysis performed by the controller using the at least one data point, is ranked as best at predicting a future value of the security from among a number of independent research providers included in a Client-specific independent research provider pool when initiating coverage for that security.

13. The system of claim 10, wherein the at least one preference includes an instruction to, when a previously selected independent research provider drops coverage for a security, automatically select an independent research provider that, based on analysis performed by the controller using the at least one data point, is ranked as best from among a number of independent research providers that are both included in a Client-specific independent research provider pool and currently covering that security.

14. The system of claim 1, further comprising at least one database including independent research generated by a plurality of independent research providers, such research being associated with the identity of the independent research providers who generated that research.

15. The system of claim 14, wherein the at least one database including independent research includes a consensus indicator indicating a consensus of independent research providers' research and analysis on each security for which there is research stored in the at least one database.

16. The system of claim 15, wherein the Client-specific report includes the consensus indicator.

17. The system of claim 17, wherein the controller is further configured to store results of a comparison of historical performances of a plurality of independent research providers that submit independent research to the system.

18. The system of claim 1, wherein the Client representative has access to all independent research relating to securities included in the Client's coverage universe generated by all independent research providers submitting independent research to the system.

19. The system of claim 18, wherein personnel of the Client other than the Client representative have access only to independent research relating to securities included in the Client's coverage universe and generated by independent research providers that are both included in a pool of independent research providers selected by the Client representative and whose research is selected by the Client representative.

20. The system of claim 1, wherein the front-end includes a plurality of graphical user interfaces including an “coverage universe” screen configured to display information associated with all of the securities included in the Client's coverage universe, each security entry including an indication of at least one independent research provider whose research is automatically delivered to the Client under the direction of the controller.

21. The system of claim 1, wherein the front-end includes a plurality of graphical user interfaces including a “security” screen configured to display information associated with a particular security including a graphical depiction of historical recommendations of the independent research provider selected by the controller and a list of all or some subset of all of the independent research providers currently transmitting independent research on the security to the system, the “security” screen also being configured to allow a user to change a ranking of the independent research providers listed on the screen to trigger an override of the automatic selection of the independent research provider for the security.

22. The system of claim 1, wherein the front-end includes a graphical user interface including an “override notes” window configured to facilitate recordation of information relevant to a user overriding automated selection of an independent research provider for a particular security.

23. The system of claim 1, wherein the front-end includes a graphical user interface including a “security research history” screen configured to display information indicating events that have occurred historically in relationship to the generation of independent research for a particular security and selection of one or more independent research providers.

24. The system of claim 1, wherein the front-end includes a graphical user interface including an “independent research provider list” screen configured to display a list of all of the independent research providers included in the Client's independent research provider pool or all of the independent research providers generating independent research on securities included in the Client's coverage universe as well as performance and coverage data on each independent research provider.

25. The system of claim 1, wherein the front-end includes a graphical user interface including an “IRP portfolio” screen configured to display a graphical depiction of a particular independent research provider's portfolio historical prediction accuracy and a listing of entries, each pertaining to a security included in the independent research provider's portfolio of securities on which the IRP generates independent research, wherein each entry includes a security name as well as corresponding research ranking and rating data.

26. The system of claim 1, wherein the front-end includes a graphical user interface including a “change history” screen configured to display a list of entries, each being associated with a change in the selection of the independent research provider whose research is automatically delivered to the Client via the system.

27. The system of claim 1, wherein the front-end includes a graphical user interface including a “search” screen configured to generate, execute and save searches for a user.

28. The system of claim 1, wherein the front-end includes a graphical user interface including a “preferences” screen configured to allow a user to customize various options and automated actions with regard to selection of an independent research provider by the controller based on certain specified events.

29. The system of claim 1, wherein the at least one data point is selected from the group consisting of: an independent research provider name, average recommendation issued by the independent research provider, adjusted performance, methodology index, coverage percentage, recommendation length, number of recommendation changes, industry, batting average, industry performance, overall matched performance, and duration that a rating has been in place.

30. The system of claim 30, wherein the instructions include a relative priority of the at least one data point.

31. A method for enabling access to, analysis of and automated delivery of independent research relating to a plurality of securities provided by a plurality of independent research providers, the method comprising:
receiving instructions, via a front-end including at least one graphical user interface, from a Client representative, the instructions including at least one data point to be used when selecting at least one independent research provider to deliver independent research on at least one security to the Client;
automatically selecting the at least one independent research provider based on the at least one data point; and
controlling automated delivery of such independent research in a Client-specific report to the Client in response to receiving such independent research from the selected independent research provider.

32. The method of claim 31, wherein the Client representative is an independent consultant hired by the Client in accordance with the Global Research Analyst Settlement announced on Apr. 28, 2003 by the Securities and Exchange Commission of the U.S. Government.

33. The method of claim 31, wherein the Client representative is personnel of the Client.

34. The method of claim 31, wherein the Client representative is a director of research for the Client.

35. The method of claim 31, wherein the Client is a securities brokerage firm or investment firm.

36. The method of claim 31, further comprising controlling automated delivery of such independent research in a Client-specific report to the Client's Customers in response to receiving such independent research from the selected independent research provider.

37. The method of claim 31, further comprising automatically selecting a new independent research provider based on the at least one data point when data associated with that at least one data point indicates that the Client representative would prefer selection of a new independent research provider, and, wherein the instructions from the Client representative include at least one preference indicating when the Client representative would prefer selection of a new independent research provider.

38. The method of claim 31, wherein the at least one data point is selected from the group consisting of: an independent research provider name, average recommendation issued by the independent research provider, adjusted performance, methodology index, coverage percentage, recommendation length, number of recommendation changes, industry, batting average, industry performance, overall matched performance, and duration that a rating has been in place.
